(19) United States
(12) Patent Application Publication
(10) Pub. No.: US 2014/0254530 A1
(43) Pub. Date: Sep. 11, 2014

(54) USER EQUIPMENT AND METHOD FOR TRANSMITTING UPLINK SIGNAL, AND BASE STATION AND METHOD FOR RECEIVING UPLINK SIGNAL

(71) Applicant: LG ELECTRONICS INC., Seoul (KR)

(72) Inventors: Hakseong Kim, Anyang-si (KR); Hanbyul Seo, Anyang-si (KR); Kijun Kim, Anyang-si (KR)

(21) Appl. No.: 14/345,584

(22) PCT Filed: Sep. 25, 2012
(86) PCT No.: PCT/KR2012/007689

§ 371 Date: Mar. 18, 2014

Related U.S. Application Data
(60) Provisional application No. 61/538,925, filed on Sep. 25, 2011.

(51) Int. Cl. H04L 5/00

(52) U.S. Cl. CPC H04L 5/0053; H04L 5/005
USPC 370/329

(57) ABSTRACT

The present invention provides a method and an apparatus for transmitting an uplink signal in a Wireless communication system, and a method and apparatus for receiving the uplink signal. A base station transmits to the user equipment a first cell identifier and a second cell identifier. The user equipment transmits an uplink control signal and a first reference signal sequence for demodulating the uplink control signal, or transmits an uplink data signal and a second reference signal sequence for demodulating the uplink data signal. A first reference signal is generated by using the first cell identifier, and a second reference signal is generated by using the second cell identifier.

### TECHNICAL FIELD

The present invention relates to a wireless communication system. Specifically, the present invention relates to a method and apparatus for transmitting an uplink signal and a method and apparatus for receiving an uplink signal.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed. In addition, a communication environment has evolved into increasing density of nodes accessible by a user at the periphery of the nodes. A node refers to a fixed point capable of transmitting/receiving a radio signal to/from a user equipment through one or more antennas. A communication system including high-density nodes may provide a better communication service to the user through cooperation between the nodes.

Such a multi-node cooperative communication scheme in which a plurality of nodes performs communication with the UE using the same time-frequency resource has much better data throughput than a conventional communication scheme in which the nodes perform communication with the UE without any cooperation by operating as independent eNBs.

A multi-node system performs cooperative communication using a plurality of nodes, each node operating as an eNB, an access point, an antenna, an antenna group, a radio remote header (RRH), or a radio remote unit (RRU). Unlike a conventional centralized antenna system in which antennas converge upon an eNB, the nodes are typically separated from each other by a predetermined interval or more in the multi-node system. The nodes may be managed by one or more eNBs or eNB controllers for controlling the operation thereof or scheduling data transmission/reception therethrough. Each node is connected to the eNB or eNB controller for managing the node through a cable or a dedicated line.

Such a multi-node system may be regarded as a type of MIMO system in that distributed nodes are capable of communicating with a single or multiple UEs by simultaneously transmitting/receiving different streams. However, since the multi-node system transmits signals using nodes distributed at various locations, a transmission region which should be covered by each antenna decreases in comparison with antennas included in the conventional centralized antenna system. Accordingly, compared with a conventional system implementing MIMO technology in the centralized antenna system, a transmit power needed when each antenna transmits a signal may be reduced in the multi-node system. In addition, since the transmission distance between an antenna and a UE is shortened, path loss is reduced and high-speed data transmission is achieved. Therefore, transmission capacity and power efficiency of a cellular system can be enhanced and relatively uniform quality of communication performance can be satisfied irrespective of the locations of UEs in a cell. Furthermore, in the multi-node system, since an eNB(s) or eNB controller(s) connected to multiple nodes performs cooperative data transmission/reception, signal loss generated in a transmission process is reduced. In addition, when nodes distant from each other by a predetermined distance or more perform cooperative communication with the UE, correlation and interference between antennas are reduced. Hence, according to the multi-node cooperative communication scheme, a high signal to interference-plus-noise ratio (SINR) can be achieved.

Due to such advantages of the multi-node system, in the next-generation mobile communication system, the multi-node system has emerged as a new basis of cellular communication through combination with or by replacing conventional centralized antenna systems in order to reduce additional installation costs of an eNB and maintenance costs of a backhaul network and simultaneously to expand service coverage and enhance channel capacity and SINR.

### DETAILED DESCRIPTION OF THE INVENTION

### Technical Problems

Due to introduction of new radio communication technology, the number of user equipments (UEs) to which an eNB should provide a service in a prescribed resource region increases and the amount of data and control information that the BS should receive/transmit from/to the UEs increases. Since the amount of resources available to the BS for communication with the UE(s) is finite, a new method in which the BS efficiently receives/transmits uplink/downlink data and/or uplink/downlink control information using the finite radio resources is needed.

Accordingly, the present invention provides a method and apparatus for efficiently transmitting/receiving an uplink/downlink signal.

The technical objects that can be achieved through the present invention are not limited to what has been particularly described hereinabove and other technical objects not described herein will be more clearly understood by persons skilled in the art from the following detailed description.

### Technical Solutions

In an aspect of the present invention, provided herein is a method for transmitting an uplink signal by a user equipment in a wireless communication system, including receiving a first cell identity and a second cell identity; and transmitting an uplink control signal and a first reference signal sequence for demodulating the uplink control signal or transmitting an uplink data signal and a second reference signal sequence for demodulating the uplink data signal, wherein the first reference signal is generated using the first cell identity and the second reference signal is generated using the second cell identity.

In another aspect of the present invention, provided herein is a user equipment for transmitting an uplink signal in a wireless communication system, including a radio frequency (RF) unit; and a processor configured to control the RF unit, wherein the processor controls the RF unit to receive a first cell identity and a second cell identity and controls the RF unit to transmit an uplink control signal and a first reference signal sequence for demodulating the uplink control signal or transmit an uplink data signal and a second reference signal sequence for demodulating the uplink data signal, and the processor generates the first reference signal using the first cell identity and the second reference signal using the second cell identity.

In another aspect of the present invention, provided herein is a method for receiving an uplink signal by a base station in a wireless communication system, including transmitting a first cell identity and a second cell identity to a user equipment; and receiving an uplink control signal and a first reference signal sequence for demodulating the uplink control signal or receiving an uplink data signal and a second reference signal sequence for demodulating the uplink data signal, from the user equipment, wherein the first reference signal is generated using the first cell identity and the second reference signal is generated using the second cell identity.

In another aspect of the present invention, provided herein is a base station for receiving an uplink signal in a wireless communication system, including a radio frequency (RF) unit; and a processor configured to control the RF unit, wherein the processor controls the RF unit to transmit a first cell identity and a second cell identity to a user equipment and controls the RF unit to receive an uplink control signal and a first reference signal sequence for demodulating the uplink control signal or receive an uplink data signal and a second reference signal sequence for demodulating the uplink data signal, from the user equipment, and the first reference signal is generated using the first cell identity and the second reference signal is generated using the second cell identity.

In each aspect of the present invention, the first cell identity may be different from the second cell identity.

In each aspect of the present invention, the uplink control signal and the first reference signal may be transmitted to a first cell and the uplink data signal and the second reference signal may be transmitted to a second cell.

The first cell identity may be the same as the second cell identity, and the uplink control signal, the first reference signal, and the uplink data signal may be transmitted to the same cell.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, when a cell transmitting a downlink signal is different from a cell receiving an uplink signal, the risk of collision between PUCCH resources can be prevented.

According to the present invention, radio resources can be prevented from colliding with each other when a user equipment receives a downlink signal from a plurality of cells or transmits an uplink signal to the plurality of cells.

According to the present invention, efficiency of use of uplink/downlink resources can be enhanced.

Effects according to the present invention are not limited to what has been particularly described hereinabove and other advantages not described herein will be more clearly understood by persons skilled in the art from the following detailed description of the present invention.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a DL subframe used in a 3GPP (3^{rd} Generation Partnership Project) LTE (Long Term Evolution)/LTE-A (Advanced) system.

FIGS. 4 and 5 illustrate time-frequency resources for cell-specific reference signals (CRSs) and demodulation reference signals (DM RSs) in an RB pair of a normal subframe having a normal cyclic prefix (CP).

FIG. 6 illustrates the structure of a UL subframe used in a 3GPP LTE/LTE-A system.

FIGS. 7 to 11 illustrate UCI transmission using physical uplink control channel (PUCCH) format 1 series, PUCCH format 2 series, and PUCCH format 3 series.

FIG. 12 illustrates multiplexing of UCI and UL data in a physical uplink shared channel (PUSCH) region.

FIG. 13 illustrates physical downlink shared channel (PDSCH) coordinated multi-point transmission/reception (CoMP) and PUCCH transmission corresponding to PDSCH CoMP.

FIG. 14 illustrates DL transmission and UL transmission when DL and UL are associated with the same cell identity (ID).

FIG. 15 illustrates DL transmission and UL transmission when DL and UL are associated with different cell IDs.

FIG. 16 illustrates a signal transmission method for DL CoMP according to an embodiment of the present invention.

FIG. 17 illustrates a signal transmission method for UL CoMP according to an embodiment of the present invention.

FIG. 18 illustrates a signal transmission method for DL CoMP and UL CoMP according to an embodiment of the present invention.

FIG. 19 is a block diagram illustrating elements of a transmitting device 10 and a receiving device 20 for implementing the present invention.

### MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a base station (BS) generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Hereinafter, a BS is referred to as an eNB.

In the present invention, a node refers to a fixed point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, a node may not be an eNB. For example, a radio remote head (RRH) or a radio remote unit (RRU) may be a node. The RRH or RRU generally has a lower power level than a power level of an eNB. Since the RRH or RRU (hereinafter, an RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port, a virtual antenna, or an antenna group. A node may be referred to as a point. Unlike a conventional centralized antenna system (CAS) (i.e. a single-node system) including antennas which converge upon an eNB and are controlled by one eNB controller, a multi-node system includes a plurality of nodes separated from one another by a predetermined distance or more. The plural nodes may be managed by one or more eNBs or eNB controllers for controlling operation thereof or scheduling data transmission/reception therethrough. Each node may be connected to an eNB or eNB controller for managing the node through a cable or a dedicated line. In the multi-node system, the same cell identity (ID) or different cell IDs may be used to transmit/receive signals to/from a plurality of nodes. If the plural nodes have the same cell ID, each of the nodes operates as a partial antenna group of one cell. If the nodes have different cell IDs in the multi-node system, the multi-node system may be regarded as a multi-cell (e.g. a macro-cell/femto-cell/pico-cell) system. If multiple cells formed respectively by multiple nodes are configured in an overlaid form according to coverage, a network formed by the multiple cells is referred to as a multi-tier network. A cell ID of an RRH/RRU may be the same as or different from a cell ID of an eNB. When the RRH/RRU and the eNB use different cell IDs, both the RRH/RRU and the eNB operate as independent eNBs.

In the multi-node system of the present invention, which will be described below, one or more eNBs or eNB controllers, connected to a plurality of nodes, may control the plural nodes to simultaneously transmit or receive signals to or from a UE through some or all of the plural nodes. Although there is a difference between multi-node systems according to the nature of each node and implementation form of each node, the multi-node systems are different from single-node systems (e.g. a CAS, a conventional MIMO system, a conventional relay system, a conventional repeater system, etc.), in that plural nodes participate in providing a communication service to a UE on a predetermined time-frequency resource. Accordingly, embodiments of the present invention regarding a method for performing cooperative data transmission using some or all of plural nodes may be applied to various types of multi-node systems. For example, while a node generally refers to an antenna group separated by a predetermined interval or more from another node, the embodiments of the present invention, which will be described later, may be applied even when a node means an arbitrary antenna group irrespective of how far the node is separated from another node. For example, when an eNB includes a cross polarized (X-pole) antenna, the embodiments of the present invention are applicable under the assumption that the eNB controls a node including a horizontally polarized (H-pole) antenna and a node including a vertically polarized (V-pole) antenna.

A communication scheme capable of transmitting/receiving a signal through a plurality of transmission (TX)/reception (RX) nodes, transmitting/receiving a signal through at least one node selected from among a plurality of TX/RX nodes, or differentiating a node transmitting a downlink signal from a node receiving an uplink signal is referred to as multi-eNB MIMO or coordinated multi-point TX/RX (CoMP). A coordinated transmission scheme of such coordinated communication between nodes may be classified largely into joint processing (JP) and scheduling coordination (CB). The JP scheme may further be divided into joint transmission (JT) and dynamic point selection (DPS) and the CB scheme may further be divided into coordinated scheduling (CS) and coordinated beamforming (CB). DPS may also be called dynamic cell selection (DCS). When JP is performed compared with other communication schemes among coordination communication schemes between nodes, a wider variety of communication environments may be formed. JT of the JP scheme is a communication scheme for transmitting the same stream to a UE from a plurality of nodes. The UE restores the stream by combining signals received from the plural nodes. JT can improve reliability of signal transmission using transmit diversity because the same stream is transmitted by plural nodes. DPS of the JP scheme is a communication scheme for transmitting/receiving a signal through one node selected according to a specific rule from among a plurality of nodes. In DPS, since a node having a good channel state with a UE will typically be selected as a communication node, reliability of signal transmission can be improved.

Meanwhile, in the present invention, a cell refers to a prescribed geographical area to which one or more nodes provide a communication service. Accordingly, in the present invention, communicating with a specific cell may mean communicating with an eNB or a node which provides a communication service to the specific cell. In addition, a downlink/uplink signal of a specific cell refers to a downlink/uplink signal from/to an eNB or a node which provides a communication service to the specific cell. Furthermore, channel status/quality of a specific cell refers to channel status/quality of a channel or communication link formed between an eNB or node which provides a communication service to the specific cell and a UE. In a 3GPP LTE-A based system, the UE may measure a downlink channel state from a specific node using a channel state information-reference signal(s) (CSI-RS(s)) transmitted on a CSI-RS resource allocated to the specific node by an antenna port(s) of the specific node. Generally, neighboring nodes transmit corresponding CSI-RSs on orthogonal CSI-RS resources. When CSI-RS resources are orthogonal, this mean that at least one of CSI-RS resource configuration which specify symbols and subcarriers carrying the CSI-RSs, subframe configuration which specify subframes, to which CSI-RSs are allocated, by using subframe offset, transmission period and etc., and/or CSI-RS sequence is different from each other.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH) and a physical uplink shared channel (PUSCH) refer to a set of time-frequency resources or REs carrying uplink control information (UCI) and a set of time-frequency resources or REs uplink data, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH transmission of a UE is conceptually identical to UCI/uplink data/random access signal transmission on PUSCH/PUCCH, respectively. In addition, PDCCH/PCFICH/PHICH/PDSCH transmission of an eNB is conceptually identical to downlink data/DCI transmission on PDCCH/PCFICH/PHICH/PDSCH, respectively.

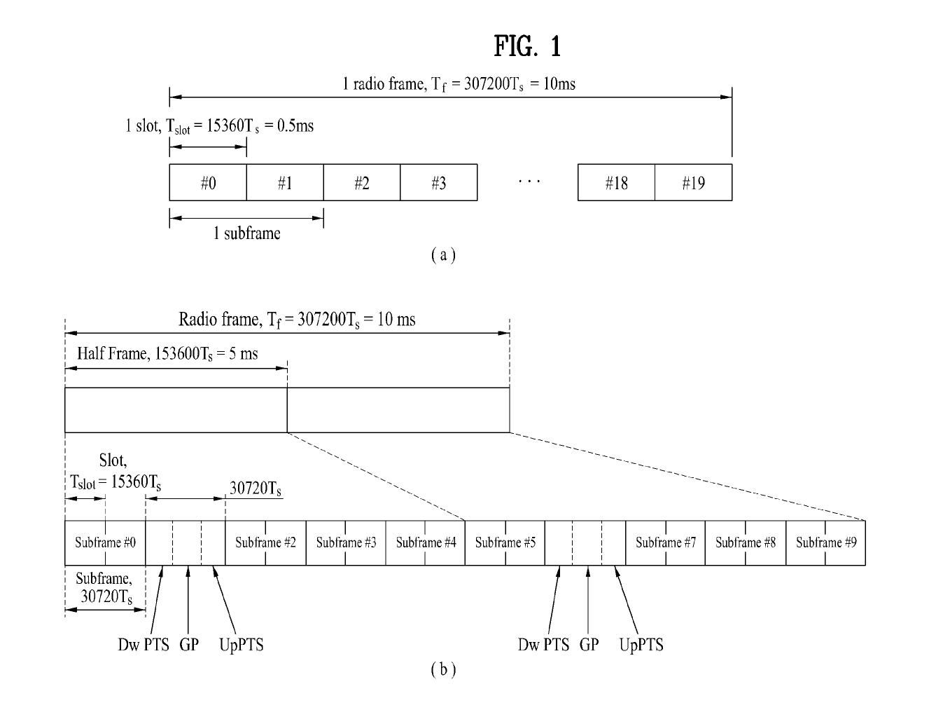

FIG. 1 illustrates the structure of a radio frame used in a wireless communication system. Specifically, FIG. 1(a) illustrates an exemplary structure of a radio frame which can be used in frequency division multiplexing (FDD) in 3GPP LTE/LTE-A and FIG. 1(b) illustrates an exemplary structure of a radio frame which can be used in time division multiplexing (TDD) in 3GPP LTE/LTE-A.

Referring to FIG. 1, a 3GPP LTE(-A) radio frame is 10 ms (307,200Tₛ) in duration. The radio frame is divided into 10 subframes of equal size. Subframe numbers may be assigned to the 10 subframes within one radio frame, respectively. Here, T, denotes sampling time where Tₛ=1/(2048*15 kHz). Each subframe is lms long and further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since downlink (DL) transmission and uplink (UL) transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| DL-UL | Downlink-to-Uplink | Subframe number | | | | | | | | | |
|---|---|---|---|---|---|---|---|---|---|---|---|
| configuration | switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

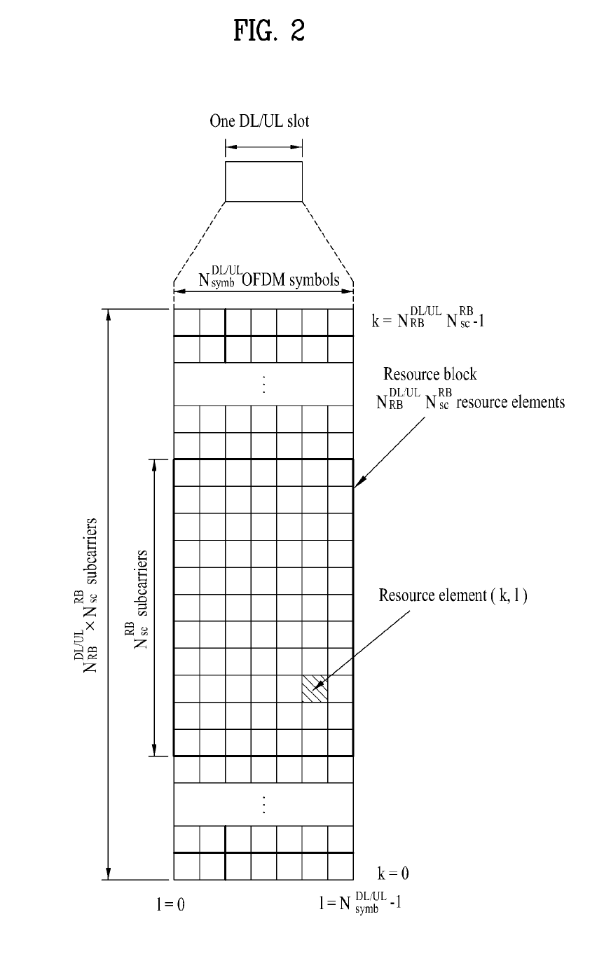

FIG. 2 illustrates the structure of a DL/UL slot structure in a wireless communication system. In particular, FIG. 2 illustrates the structure of a resource grid of a 3GPP LTE(-A) system. One resource grid is defined per antenna port.

A slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of resource blocks (RBs) in a DL slot and N^{UL}_{RB} denotes the number of RBs in a UL slot. N^{DL}_{RB} and N^{DL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RD}_{sc} denotes the number of subcarriers configuring one RB.

An OFDM symbol may be referred to as an OFDM symbol, an SC-FDM symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency.

One RB is defined as N^{DL/UL}_{symb} (e.g. 7) consecutive OFDM symbols in the time domain and as N^{RB}(e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sC} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}1−1 in the time domain.

In one subframe, two RBs each located in two slots of the subframe while occupying the same N^{RD}_{sc} consecutive subcarriers are referred to as a physical resource block (PRB) pair. Two RBs configuring a PRB pair have the same PRB number (or the same PRB index).

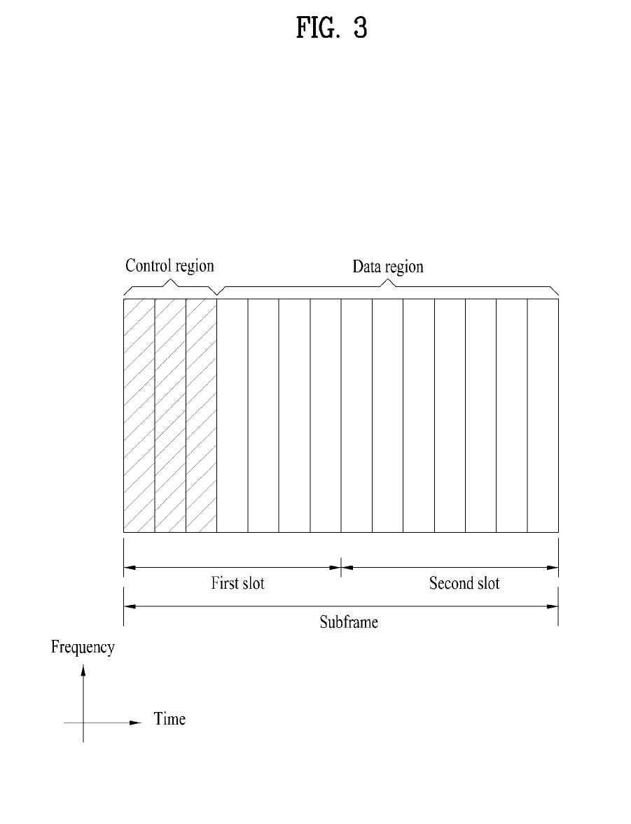

FIG. 3 illustrates the structure of a DL subframe used in a 3GPP LTE(-A) system.

A DL subframe is divided into a control region and a data region in a time domain. Referring to FIG. 3, a maximum of 3 (or 4) OFDM symbols located in a front part of a first slot of a subframe correspond to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region. Examples of a DL control channel used in 3GPP LTE include a physical control format indicator channel (PCFICH), a physical downlink control channel (PDCCH), a physical hybrid ARQ indicator channel (PHICH), etc. The PCFICH is transmitted in the first OFDM symbol of a subframe and carries information about the number of OFDM symbols available for transmission of a control channel within a subframe. The PHICH carries a HARQ (Hybrid Automatic Repeat Request) ACK/NACK (acknowledgment/negative-acknowledgment) signal as a response to UL transmission.

The control information transmitted through the PDCCH will be referred to as downlink control information (DCI). The DCI includes resource allocation information for a UE or UE group and other control information. For example, the DCI includes transport format and resource allocation information of a downlink shared channel (DL-SCH), transport format and resource allocation information of an uplink shared channel (UL-SCH), paging information on a paging channel (PCH), system information on the DL-SCH, resource allocation information of upper layer control message such as random access response transmitted on the PDSCH, a set of transmission (Tx) power control commands of individual UEs within a UE group, Tx power control information, and activity information of voice over Internet protocol (VoIP). The size and usage of the DCI carried by one PDCCH are varied depending on DCI formats. The size of the DCI may be varied depending on a coding rate. In the current 3GPP LTE system, various formats are defined, wherein format 0 is defined for a UL, and formats 1, 1A, 1B, 1C, 1D, 2, 2A, 3, and 3A are defined for a DL. Combination selected from control information such as a hopping flag, RB allocation, modulation coding scheme (MCS), redundancy version (RV), new data indicator (NDI), transmit power control (TPC), cyclic shift, cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

Generally, a DCI format capable of being transmitted to the UE differs according to transmission mode (TM) configured for the UE. In other words, for the UE configured as a specific TM, all DCI formats cannot be used and only predetermined DCI format(s) corresponding to the specific TM can be used.

A PDCCH is transmitted on one control channel element (CCE) or an aggregate of a plurality of consecutive CCEs. The CCE is a logical allocation unit used to provide a coding rate to a PDCCH based on a radio channel state. The CCE corresponds to a plurality of resource element groups (REGs). For example, one CCE corresponds to 9 REGs and one REG corresponds to 4 REs. In a 3GPP LTE system, a CCE set in which a PDCCH can be located for each UE is defined. A CCE set in which the UE can detect a PDCCH thereof is referred to as a PDCCH search space or simply as a search space (SS). An individual resource on which the PDCCH can be transmitted in the SS is called a PDCCH candidate. A set of PDCCH candidates that the UE is to monitor is defined as the SS. In the 3GPP LTE/LTE-A system, SSs for respective PDCCH formats may have different sizes and a dedicated search space and a common search space are defined. The dedicated search space is a UE-specific search space and is configured for each individual UE. The common search space is configured for a plurality of UEs. One PDCCH candidate corresponds to 1, 2, 4, or 8 CCEs according to CCE aggregation levels. An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

The eNB may transmit data to a UE or UE group in the data region. Data transmitted in the data region is referred to as user data. A PDSCH may be allocated to the data region for user data transmission. The PCH and the DL-SCH are transmitted on the PDSCH. A UE may decode control information received on a PDCCH and thus read data received on the PDSCH. The size and usage of DCI transmitted on one PDCCH may vary according to DCI format and the size of the DCI may vary according to coding rate. Information indicating to which UE or UE group PDSCH data is transmitted and information indicating how the UE or UE group should receive and decode the PDSCH data are transmitted on the PDCCH. For example, it is assumed that a specific PDCCH is CRC-masked with a radio network temporary identity (RNTI) ‘A’ and information about data transmitted using a radio resource ‘B’ (e.g. frequency location) and using transport format information ‘C’ (e.g. transmission block size, modulation scheme, coding information, etc.) is transmitted in a specific DL subframe. Then, the UE monitors the PDCCH using RNTI information thereof. The UE having the RNTI ‘A’ receives the PDCCH and receives the PDSCH indicated by ‘B’ and ‘C’ through information of the received PDCCH.

For demodulation of a signal transmitted between an eNB and a UE, a reference signal (RS) to be compared with a data signal is needed. The RS indicates a signal of a predefined special waveform, known to the eNB and UE, transmitted from the eNB to the UE or from the UE to the eNB and is referred to as a pilot signal. RSs are classified into a cell-specific RS (CRS) commonly used by all UEs in a cell and a demodulation RS (DM RS) dedicated to a specific UE. A DM RS that the eNB transmits for DL data demodulation for a specific UE may be referred to specifically as a UE-specific RS. The DL DM RS and CRS may be transmitted together or one of the DM RS or the CRS may be transmitted. Nonetheless, in the case in which only the DM RS is transmitted without the CRS, an RS for channel measurement should be separately provided because the DM RS transmitted by applying the same precoder as data can be used only for demodulation. For example, in 3FPP LTE(-A), a CSI-RS, which is an additional RS for measurement, is transmitted to the UE so that the UE may measure CSI. The CSI-RS is transmitted in every prescribed transmission period comprised of multiple subframes, unlike a CRS transmitted in every subframe, based on the fact that channel state does not undergo a substantial variation over time.

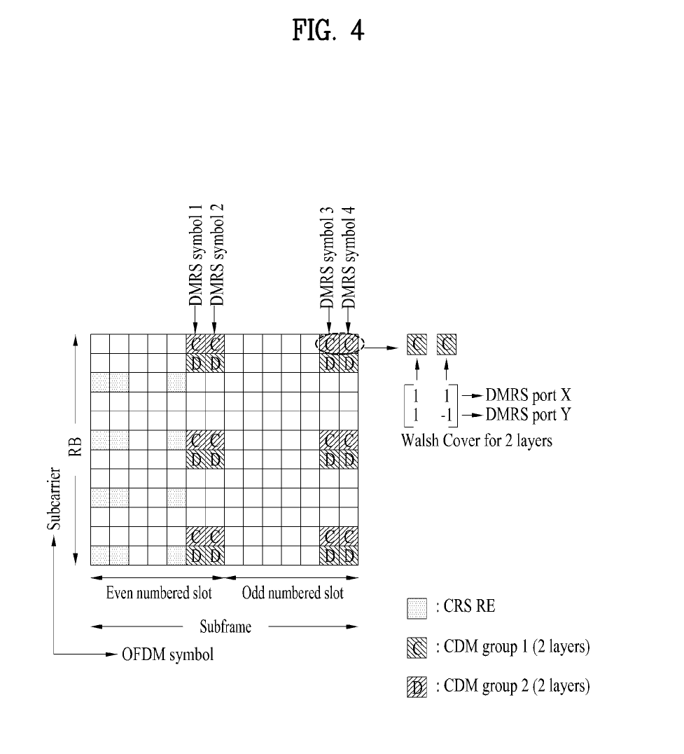

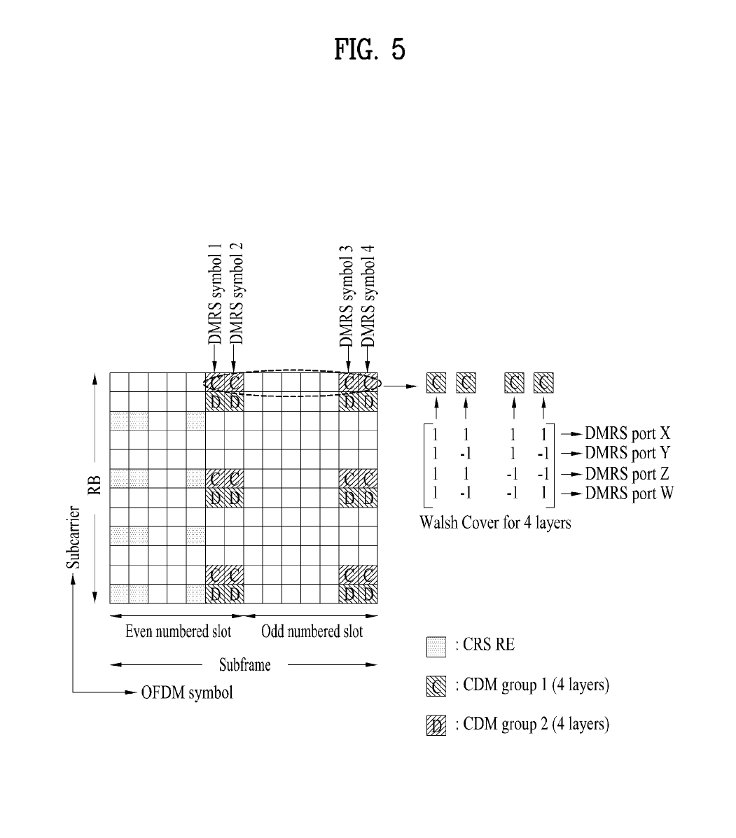

FIGS. 4 and 5 illustrate time-frequency resources for CRSs and DM RSs in an RB pair of a normal subframe having a normal CP. Specifically, FIG. 4 illustrates a method for multiplexing a maximum of 4 DM RSs with two CDM groups and FIG. 5 illustrates a method for multiplexing a maximum of 8 DM RSs with two CDM groups.

Referring to FIGS. 4 and 5, DM RSs are defined in a PRB pair in a 3GPP LTE(-A) system. Hereinbelow, among REs of one PRB pair, a set of REs in which distinguishable DM RSs extended by orthogonal cover codes are transmitted is referred to as a code division multiplexing (CDM) group. The orthogonal cover code may be, for example, a Walsh-Hadmard code. The orthogonal cover code may also be called an orthogonal sequence. Referring to FIGS. 4 and 5, REs denoted by ‘C’ belong to one CDM group (hereinafter, CDM group 1) and REs denoted by ‘D’ belong to another CDM group (hereinafter, a CDM group 2).

In a 3GPP LTE(-A) system, a plurality of layers may be multiplexed in one subframe and then is transmitted to a receiving device. In the present invention, a layer transmitted by a transmitting device indicates an information input path to a precoder. The layer may be referred to as a transmission layer, a stream, a transmission stream, or a data stream. Transmission data is mapped to one or more layers. Therefore, data is transmitted from the transmitting device to the receiving device by one or more layers. In case of multi-layer transmission, the transmitting device transmits DM RS per layer, and the number of DM RSs increases in proportion to the number of transmission layers.

One antenna port may transmit one layer and one DM RS. When the transmitting device needs to transmit 8 layers, a maximum of four antenna ports may transmit four DM RSs using one CDM group. For example, referring to FIG. 5, DM RS port X, DM RS port Y, DM RS port Z, and DM RS port W may transmit four DM RSs spread by different orthogonal sequences, respectively, using the same CDM group. The receiving device may detect the DM RSs from signals received on four consecutive DM RS REs in an OFDM direction, using orthogonal sequences used to multiplex the DM RSs on the four DM RS REs.

A DM RS is generated from a seed value based on a physical layer cell ID N^{cell}_{ID}. For example, for any of antenna ports pε{7, 8, . . . , γ+6}, the DM RS may be defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normalcyclicprefix \\ 0 , 1 , … , 16 {N}_{RB}^{max , DL} - 1 & extendedcyclicprefix\end{matrix} \qquad [ Equation 1 ]$$

In Equation 1, N^{max,DL}_{RB} is the largest DL bandwidth configuration, expressed in multiples of N^{RB}_{sc}. The pseudo-random sequence c(i) may be defined by a length-31 Gold sequence. The output sequence c(n) of length M_{PN}, where n=0, 1, . . . , M_{PN}−1, is defined by the following equation.

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2 [Equation 2]

In Equation 2, N_{C}=1600 and the first m-sequence is initialized with x₁(0)=1, x₁(n)=0, n=1, 2, . . . , 30. The initialization of the second m-sequence is denoted by the following equation with a value depending on the application of the sequence.

cᵢₙᵢₜ=Σᵢ₌₀³⁰x₂(i)·2ⁱ [Equation 3]

For Equation 1, the pseudo-random sequence generator is initialized with the following equation at the start of each subframe.

cᵢₙᵢₜ=(└nₛ/2┘+1)·(2N_{ID}^{cell}+1)·2¹⁶+n_{SCID} [Equation 4]

In Equation 4, the value of n_{SCID} is zero unless specified otherwise. For a PDSCH transmission on ports 7 or 8, n_{SCID} is given by the DCI format 2B or 2C associated with the PDSCH transmission. DCI format 2B is a DCI format for resource assignment for a PDSCH using up to two antenna ports with DM RSs and DCI format 2C is a DCI format for resource assignment for a PDSCH using up to 8 antenna ports with DM RSs. In the case of DCI format 2B, n_{SCID} is indicated by the scrambling identity field according to Table 3. In the case of DCI format 2C, n_{SCID} is given by Table 4.

TABLE 3

| Scrambling identity field in | |
|---|---|
| DCI format 2B | n_{SCID} |
| 0 | 0 |
| 1 | 1 |

TABLE 4

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

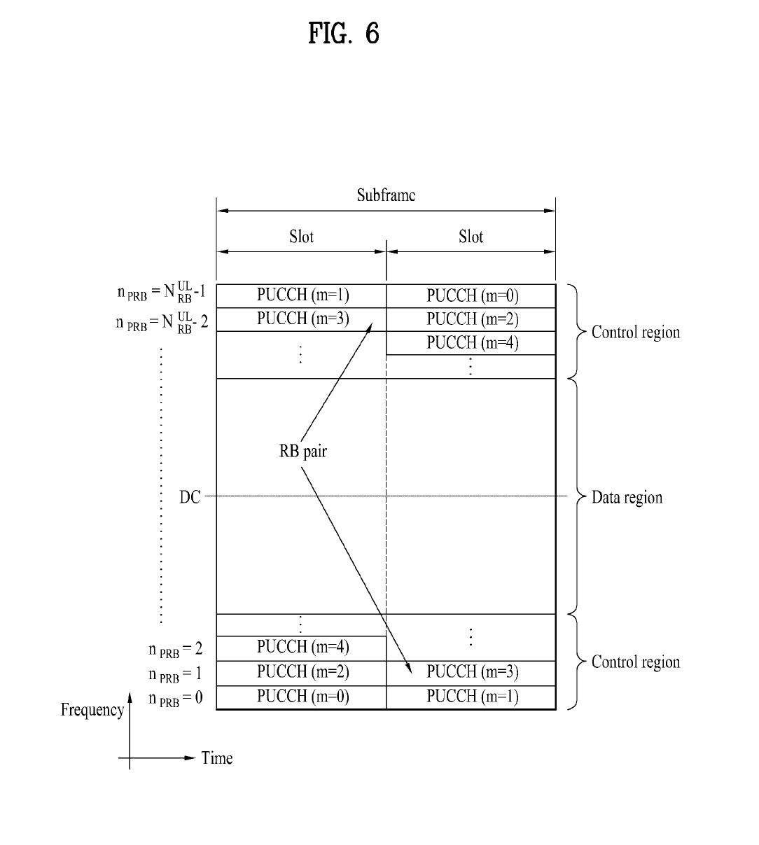

FIG. 6 illustrates the structure of a UL subframe used in a 3GPP LTE(-A) system.

Referring to FIG. 6, a UL subframe may be divided into a data region and a control region in the frequency domain. One or several PUCCHs may be allocated to the control region to deliver UCI. One or several PUSCHs may be allocated to the data region of the UE subframe to deliver user data.

In the UL subframe, subcarriers distant from a direct current (DC) subcarrier are used as the control region. In other words, subcarriers located at both ends of a UL transmission bandwidth are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. MIMO-related feedback information includes a rank indicator (RI) and a precoding matrix indicator (PMI).

The amount of UCI that can be transmitted by a UE in a subframe depends on the number of SC-FDMA symbols available for control information transmission. SC-FDMA symbols available for UCI correspond to SC-FDMA symbols other than SC-FDMA symbols used for reference signal transmission in a subframe. In the case of a subframe in which an SRS is configured, the last SC-FDMA symbol in the subframe is excluded from the SC-FDMA symbols available for UCI. A reference signal is used for coherent PUCCH detection. A PUCCH supports various formats according to transmitted information.

Table 5 shows a mapping relationship between PUCCH formats and UCI in an LTE/LTE-A system.

TABLE 5

| | | Number of | | |
|---|---|---|---|---|
| PUCCH | Modulation | bits per | | |
| format | scheme | subframe | Usage | Etc. |
| 1 | N/A | N/A (exist | SR (Scheduling | |
| | | or | Request) | |
| | | absent) | | |
| 1a | BPSK | 1 | ACK/NACK or | One codeword |
| | | | SR + ACK/NACK | |
| 1b | QPSK | 2 | ACK/NACK or | Two |
| | | | SR + ACK/NACK | codewords |
| 2 | QPSK | 20 | CQI/PMI/RI | Joint coding |
| | | | | ACK/NACK |
| | | | | (extended CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK | |
| | | | or | |
| | | | CQI/PMI/RI + | |
| | | | ACK/NACK | |

Referring to Table 3, PUCCH format 1 series are mainly used to transmit ACK/NACK information, PUCCH format 2 series are mainly used to carry channel state information (CSI) such as channel quality indicator (CQI)/precoding matrix indicator (PMI)/rank indicator (RI), and PUCCH format 3 series are mainly used to transmit ACK/NACK information.

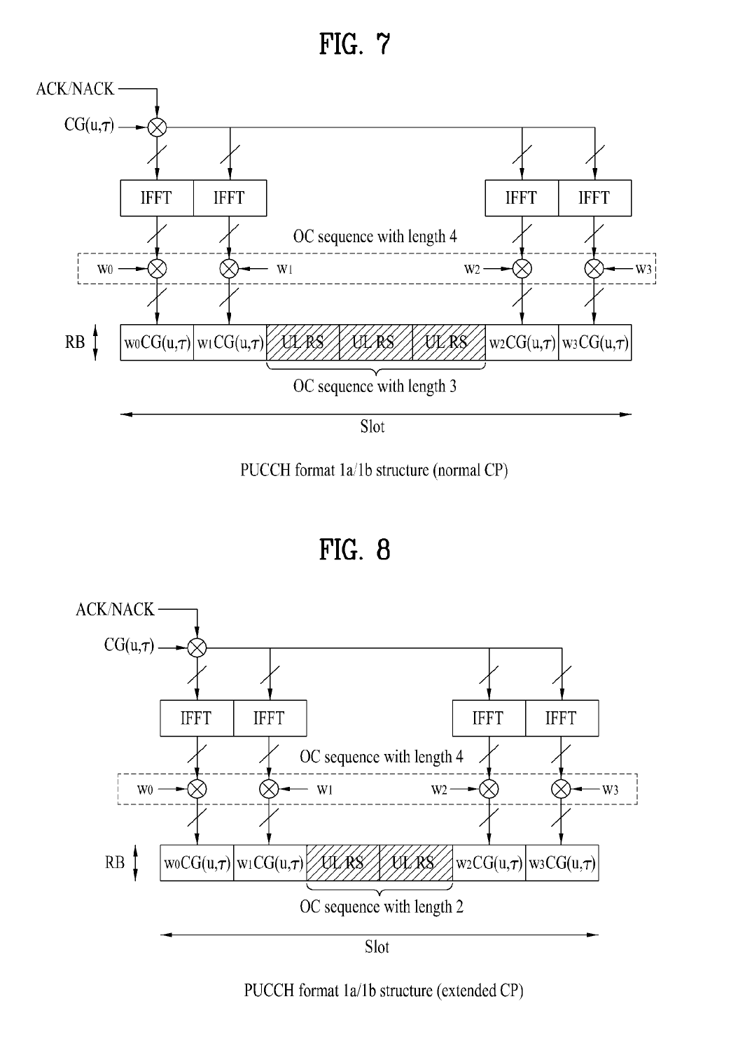

FIGS. 7 to 11 illustrate UCI transmission using PUCCH format 1 series, PUCCH format 2 series, and PUCCH format 3 series.

In a 3GPP LTE/LTE-A system, a DL/UL subframe having a normal CP consists of two slots each including 7 OFDM symbols and a DL/UL subframe having an extended CP consists of two slots each having 6 OFDM symbols. Since the number of OFDM symbols in each subframe varies with CP length, a structure in which a PUCCH is transmitted in a UL subframe also varies with CP length. Accordingly, a UCI transmission method of a UE in the UL subframe depends on a PUCCH format and CP length.

Referring to FIGS. 7 and 8, control information transmitted using PUCCH formats 1a and 1b is repeated with the same contents on a slot basis in a subframe. Each UE transmits an ACK/NACK signal on different resources including different cyclic shifts (frequency domain codes) of a computer-generated constant amplitude zero autocorrelation (CG-CAZAC) sequence and orthogonal covers (OCs) or orthogonal cover codes (OCCs) (time domain spreading codes). An OCC is referred to as an orthogonal sequence. An OC includes, for example, a Walsh/discrete Fourier transform (DFT) OC. Provided that the number of cyclic shifts is 6 and the number of OCs is 3, a total of 18 PUCCHs may be multiplexed in the same physical resource block (PRB) based on a single antenna port. Orthogonal sequences w₀, w₁, w₂ and w₃ may be applied in either an arbitrary time domain (after fast Fourier transform (FFT) modulation) or an arbitrary frequency domain (before FFT modulation). In the 3GPP LTE/LTE-A system, PUCCH resources for ACK/NACK transmission are expressed as a combination of a position of a time-frequency resource (e.g. PRB), a cyclic shift of a sequence for frequency spreading, and a (quasi) OC for time spreading and each PUCCH resource is indicated using a PUCCH resource index (also referred to as a PUCCH index). PUCCH format 1 series for scheduling request (SR) transmission is the same in a slot level structure as PUCCH format 1a and 1b and differs only in a modulation method from the PUCCH formats 1a and 1b.

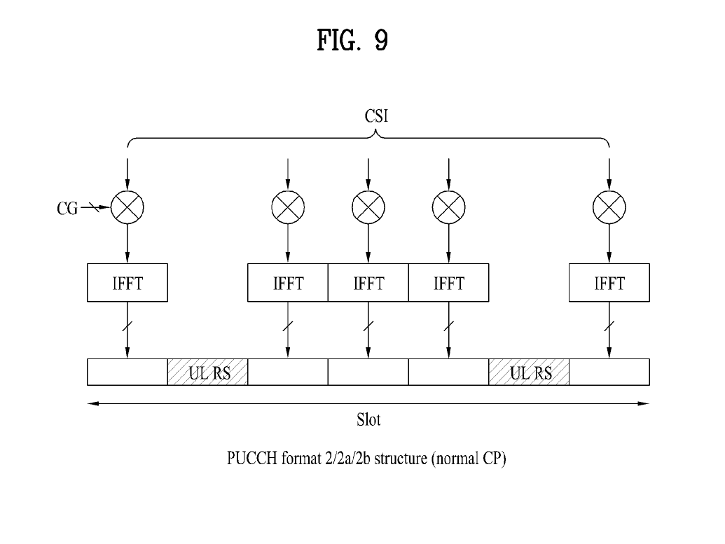

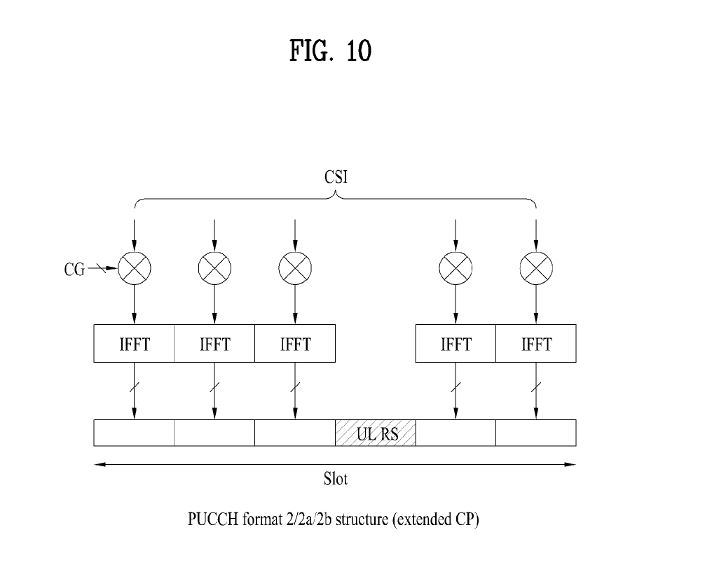

FIG. 9 illustrates an example of transmitting channel state information (CSI) using PUCCH formats 2/2a/2b in a UL slot having a normal CP and FIG. 10 illustrates an example of transmitting CSI using PUCCH formats 2/2a/2b in a UL slot having an extended CP.

Referring to FIGS. 9 and 10, in a normal CP, one UL subframe includes 10 OFDM symbols except for a symbol carrying a UL RS. CSI is coded into 10 transport symbols (also referred to as complex-valued modulation symbols) through block coding. The 10 transport symbols are mapped to the 10 OFDM symbols, respectively, and then are transmitted to an eNB.

PUCCH format 1/1a/1b and PUCCH format 2/2a/2b may carry only up to a predetermined number of bits. However, as carrier aggregation and the number of antennas have increased and a TDD system, a relay system, and a multi-node system have been introduced, the amount of UCI has increased and thus a PUCCH format capable of carrying more UCI than PUCCH format 1/1a/1b/2/2a/2b has been introduced. This format is referred to as PUCCH format 3. For instance, PUCCH format 3 may be used when a UE for which carrier aggregation is configured transmits, through a specific UL carrier, a plurality of ACK/NACK signals for a plurality of PDSCHs received from the eNB through a plurality of DL carriers.

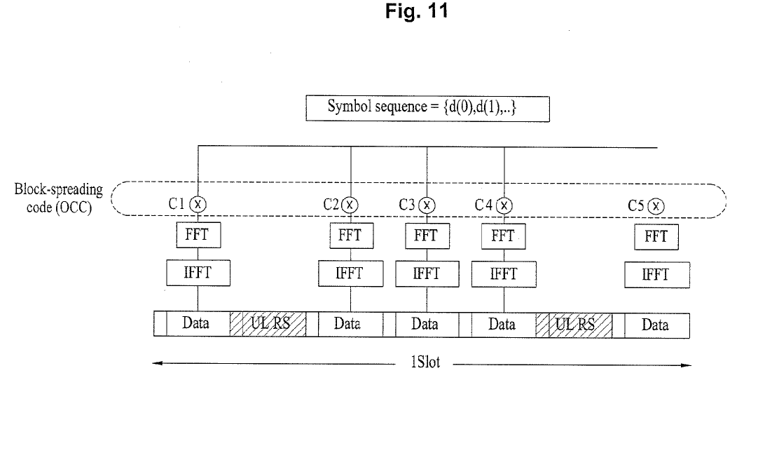

PUCCH format 3 may be configured based on, for example, block-spreading. Referring to FIG. 11, block-spreading is a scheme for spreading a symbol sequence by an OCC (also called an orthogonal sequence) on the time domain and transmitting the spread symbol sequence. According to the block-spreading scheme, control signals of multiple UEs may be multiplexed on the same RB by the OCC and transmitted to an eNB. In PUCCH format 2, one symbol sequence is transmitted over the time domain, and UCI of the UEs is multiplexed using a cyclic shift of a CAZAC sequence and transmitted to the eNB. On the other hand, in a new PUCCH format based on block spreading (hereinafter, PUCCH format 3), one symbol sequence is transmitted over the frequency domain, and the UCI of the UEs is multiplexed using OCC based time-domain spreading and transmitted to the eNB. For example, referring to FIG. 9, one symbol sequence is spread by a length-5 (i.e. spreading factor (SF)=5) OCC and mapped to five SC-FDMA symbols. While a total of two RS symbols is used in one slot in FIG. 11, three RS symbols may be used and an OCC of SF=4 may be used to spread a symbol sequence and multiplex signals of UEs. The RS symbols may be generated by a CAZAC sequence having a specific cyclic shift and may be transmitted to the eNB from the UE in a manner of applying (multiplying) a specific OCC to/by a plurality of RS symbols in the time domain. In FIG. 11, DFT may be applied prior to the OCC and FFT may be applied instead of DFT.

In FIGS. 7 to 11, UL RSs transmitted along with UCI on a PUCCH may be used to demodulate the UCI at the eNB.

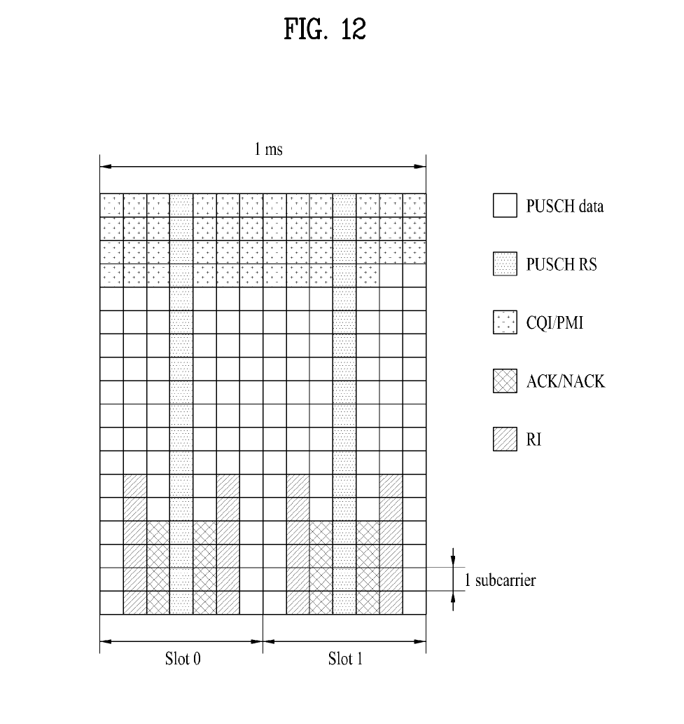

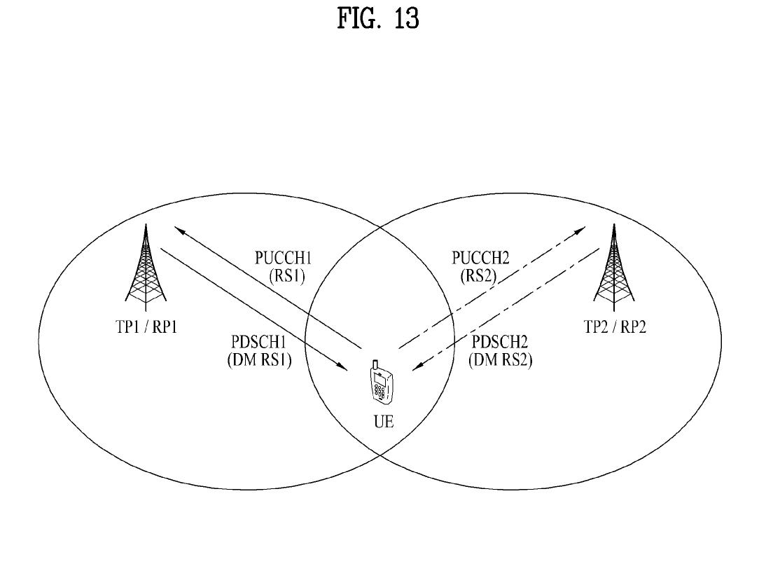

FIG. 12 illustrates multiplexing of UCI and UL data in a PUSCH region.

UL data may be transmitted through a PUSCH in a data region of a UL subframe. A DM RS, which is an RS signal used to demodulate the UL data, may be transmitted together with the UL data in a data region of the UL subframe. Hereinafter, a control region and a data region in the UL subframe will be referred to as a PUCCH region and a PUSCH region, respectively.

If UCI needs to be transmitted in a subframe to which PUSCH transmission is allocated, the UE multiplexes the UCI and UL data (hereinafter, PUSCH data) prior to DFT-spreading and transmits the multiplexed UL signal on a PUSCH, unless simultaneous transmission of a PUSCH and PUCCH is permitted. The UCI includes at least one of CQI/PMI, HARQ ACK/NACK, and RI. The number of REs used for CQI/PMI, ACK/NACK, and RI transmission is based on a modulation and coding scheme (MCS) allocated for PUSCH transmission and on offset values Δ^{CQ1}_{offset}, Δ^{HARQ-ACK}_{offset}, and Δ^{RI}_{offset}. The offset values permit different coding rates according to UCI and are semi-statically configured by higher-layer (e.g. radio resource control (RRC) signaling. The PUSCH data and UCI are not be mapped to the same RE. The UCI is mapped to both slots of a subframe.

Referring to FIG. 12, CQI and/or PMI (CQI/PMI) resources are located at the start part of PUSCH data resources. The CQI/PMI resources are sequentially mapped to all SC-FDMA symbols on one subcarrier and then are mapped on the next subcarrier. The CQI/PMI resources are mapped starting from left to right, that is, in the direction of ascending SC-FDMA symbol index, within a subcarrier. The PUSCH data is rate-matched in consideration of the amount of the CQI/PMI resources (i.e. the number of coded symbols). A modulation order which is the same as the modulation order of UL-SCH data is used for CQI/PMI. ACK/NACK is inserted through puncturing part of SC-FDMA resources to which UL-SCH data is mapped. ACK/NACK is located besides a PUSCH RS which is an RS used to demodulate the PUSCH data and is filled starting bottom to top, that is, in the direction of ascending subcarrier index, within an SC-FDMA symbol. In the case of a normal CP, SC-FDMA symbols for ACK/NACK are located at SC-FDMA symbols #2/#5 in each slot as illustrated in FIG. 12. Irrespective of whether ACK/NACK is actually transmitted in a subframe, a coded RI is located next to the symbol for ACK/NACK.

In 3GPP LTE, UCI may be scheduled to be transmitted on a PUSCH without PUSCH data. ACK/NACK, RI, and CQI/PMI may be multiplexed in a similar way to multiplexing as illustrated in FIG. 12. Channel coding and rate matching for control signaling without the PUSCH data are identical to channel coding and rate matching for control signaling with the PUSCH data.

In FIG. 12, the PUSCH RS may be used to demodulate the UCI and/or the PUSCH data transmitted in a PUSCH region. In the present invention, a UL RS associated with PUCCH transmission and a PUSCH RS associated with PUSCH transmission are referred to as a DM RS.

Meanwhile, although not shown in FIG. 12, a sounding reference signal (SRS) may be allocated to a PUSCH region. The SRS is a UL RS not associated with PUSCH or PUCCH transmission. The SRS is transmitted on an OFDM symbol which is located at the last part of a UL subframe in the time domain and on a data transmission band of the UL subframe, that is, on the PUSCH region, in the frequency domain. The eNB may measure a UL channel state between the UE and the eNB using the SRS. SRSs of multiple UEs transmitted/received on the last OFDM symbol of the same subframe may be distinguished according to a frequency location/sequence.

Since the UL RS, the PUSCH RS, and the SRS are UE-specifically generated by a specific UE and are transmitted to the eNB, theses signals may be called UL UE-specific RSs.

The UL UE-specific RS is defined by a cyclic shift of a base sequence according to a predetermined rule. For example, an RS sequence r^{(u)}_{u,v}(n) is defined by a cyclic shift α of a base sequence r_{u,v}(n).

r_{u,v}^{(α)}(n)=e^{jαn}·r_{u,v}(n),0≦n<M_{SC}^{RS} [Equation 5]

In Equation 5, M^{RS}_{sc}=m·N^{RB}_{sc} is the length of the reference signal sequence and 1≦m≦N^{max,UL}_{RB}·N^{max,UL}_{RB} is the largest UL bandwidth configuration, expressed in multiples of N^{RB}_{sc}. Multiple reference signal sequences may be defined from a single base sequence through different values of a. For a DM RS and an SRS, a plurality of base sequences is defined. For example, base sequences may be defined using a root Zadoff-Chu sequence. Base sequences r_{u,v}(n) are divided into groups. Each base sequence group contains one or more base sequences. For example, each base sequence group may contain one base sequence (v=0) of each length M^{RS}_{sc}=m·N^{RB}_{sc (}1≦m≦5) and two base sequences of each length M^{RS}_{sc}=m·N^{RB}_{sc} (6≦m≦N^{RB}_{sc}). In r_{u,v}(n), uε{0, 1, . . . , 29} is the group number (i.e. group index), v is the base sequence number within the group (i.e. base sequence index). The sequence group number u and the number v within the group may vary in time.

The sequence-group number u in slot nₛ is defined by a group hopping pattern f_{gh}(nₛ) and a sequence-shift pattern fₛₛ according to the following equation.

u=(f_{gh}(nₛ)+fₛₛ)mod 30 [Equation 6]

There are plural different (e.g. 17) hopping patterns and plural different (e.g. 30) sequence shift patterns. Sequence-group hopping can be enabled or disabled by a cell-specific parameter provided by higher layers.

The group-hopping pattern f_{gh}(nₛ) may be given for PUSCH and PUCCH by the following equation.

$${f}_{gh} ( {n}_{s} ) = \{ \begin{matrix}0 & if group hopping is disabled \\ ( {\sum }_{i = 0}^{7} c ( 8 {n}_{s} + i ) \cdot {2}^{i} ) mod 30 & if group hopping is enabled\end{matrix} \qquad [ Equation 7 ]$$

In Equation 7, the pseudo-random sequence c(i) is defined by Equation 2. The pseudo-random sequence generator is initialized with cᵢₙₜ according to the following equation at the beginning of each radio frame.

$${c}_{init} = ⌊ \frac{{N}_{ID}^{cell}}{30} ⌋ \qquad [ Equation 8 ]$$

According to the current 3GPP LTE(-A) standards, the group-hopping pattern is the same for PUSCH and PUCCH according to Equation 7, but the sequence-shift pattern differs between PUCCH and PUSCH. For PUCCH, the sequence-shift pattern f^{PUCCH}ₛₛ is given by the following equation based on the cell ID.

fₛₛ^{PUCCH}=N_{ID}^{cell} mod 30 [Equation 9]

A sequence shift pattern for a PUSCH f^{PUCCH}ₛₛ is given by the following equation using a sequence shift pattern f^{PUCCH}ₛₛ for a PUCCH and a value (Δₛₛ) configured by higher layers.

fₛₛ^{PUSCH}=(fₛₛ^{PUCCH}+Δₛₛ)mod 30 [Equation 10]

In Equation 10, Δₛₛε{0, 1, . . . , 29}.

Base sequence hopping only applies for RSs of length M^{RS}_{sc}≧6N^{RB}_{sc}. For RSs of length M^{RS}_{sc}<6N^{RB}_{sc}, the base sequence number v within the base sequence group is given by v=0. For RSs of length M^{RS}_{sc}≧6N^{RB}_{sc}, the base sequence number v within the base sequence group in slot nₛ is defined by v=c(nₛ) if group hopping is disabled and sequence hopping is enabled, otherwise defined by v=0, where the pseudo-random sequence c(i) is given by Equation 2. The pseudo-random sequence generator is initialized with cᵢₙᵢₜ according to the following equation at the beginning of each radio frame.

$${c}_{init} = ⌊ \frac{{N}_{ID}^{cell}}{30} ⌋ \cdot {2}^{5} + {f}_{ss}^{PUSCH} \qquad [ Equation 11 ]$$

A sequence r^{(p)}_{PUCC}(.) of a UL RS of FIGS. 7 to 11 (hereinafter, a PUCCH DM RS) is given by

$${r}_{PUCCH}^{( p )} ( {m}^{′} {N}_{RS}^{PUCCH} {M}_{sc}^{RS} + {mM}_{sc}^{RS} + n ) = \frac{1}{\sqrt{P}} {\overline{w}}^{( p )} ( m ) z ( m ) {r}_{u , v}^{( α\_ p )} ( n ) \qquad [ Equation 12 ]$$

In Equation 12, m=0, . . . , N^{PUCCH}_{RS}−1, n=0, . . . , M^{RS}_{sc}−1, and m′−0,1. N^{PUCCH} is the number of reference symbols per slot for PUCCH. P is the number of antenna ports used for PUCCH transmission. The sequence r^{(α}^{_{—}}^{p})_{u,v}(n) is given by Equation 5 with M^{RS}_{sc}=12 where the cyclic shift α_p is determined by the PUCCH format.

For PUCCH formats 2a and 2b, z(m) equals to d(10) for m=1. For all other cases, z(m)=1. For PUCCH formats 2a and 2b, supported for normal cyclic prefix only, the bit(s) b(20), . . . , b(M_{bit}−1) among b(0), . . . , b(M_{bit}−1) are modulated as described in the following table resulting a single modulation symbol d(10) used in the generation of the RS for PUCCH format 2a and 2b.

TABLE 6

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

A PUSCH RS of FIG. 12 (hereinafter, PUSCH DM RS) is transmitted per layer. A PUSCH DM RS sequence r^{(p)}_{PUSCH}(.) associated with a layer λε{0, 1, . . . , v−1} is given by

r_{PUSCH}^{(λ)}(m·M_{sc}^{RS}+n)=w^{(λ)}(m)r_{u,v}^{(α}^{_{—}}^{λ)}(n) [Equation 13]

In Equation 13, m=0,1, n=0, . . . , M^{RS}_{sc}−1, M^{rs}_{sc}=M^{PUSCH}_{sc}. M^{PUSCH}_{sc} is scheduled bandwidth for UL transmission, expressed as a number of subcarriers. The orthogonal sequence w^{(λ)}(m) may be given by Table 7 using the cyclic shift field in most recent UL-related DCI for the transport block associated with the corresponding PUSCH transmission. Table 7 shows an example mapping of cyclic shift field in UL-related DCI format to n⁽²⁾_{DMRS,λ} and [w^{(λ)}(0) w^{(λ)}(1)].

TABLE 7

| Cyclic Shift Field | | | | | | | | |
|---|---|---|---|---|---|---|---|---|
| in uplink-related | n_{DMRS, λ}⁽²⁾ | | | | [w^{(λ)} (0) w^{(λ)} (1)] | | | |
| DCI format | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

The cyclic shift α_λ in slot nₛ is given as 2πn_{cs,λ}/12 with n_{cs,λ}=(n⁽¹⁾_{DMRS}+n⁽²⁾_{DMRS,λ}+n_{PN}(nₛ)mod 12. n⁽¹⁾_{DMRS} is given by Table 8 according to cyclicShift provided by higher layers. Table 8 shows a mapping of cyclicShift given by higher layers to n⁽¹⁾_{DMRS}.

TABLE 8

| cyclicShift | n⁽¹⁾_{DMRS} |
|---|---|
| 0 | 0 |
| 1 | 2 |
| 2 | 3 |
| 3 | 4 |
| 4 | 6 |
| 5 | 8 |
| 6 | 9 |
| 7 | 10 |

n_{PN}(nₛ) is given by the following equation using the cell-specific pseudo-random sequence c(i).

n_{PN}(nₛ)=Σᵢ₌₀⁷c(8N_{symb}^{UL}·nₛ+i)·2ⁱ [Equation 14]

In Equation 14, the pseudo-random sequence c(i) is defined by Equation 2. The pseudo-random sequence generator is initialized with cᵢₙᵢₜ according to the following equation at the beginning of each radio frame.

$${c}_{init} = ⌊ \frac{{N}_{ID}^{cell}}{30} ⌋ \cdot {2}^{5} + {f}_{ss}^{PUSCH} \qquad [ Equation 15 ]$$

Meanwhile, the SRS sequence r^{(p)}_{SRS}(n)=r^{(α}^{_{—}}^{p)}_{u,v}(n) is given by Equation 5, where u is the PUCCH sequence-group number described in the afore-mentioned group hopping, v is the base sequence number described in the afore-mentioned sequence hopping. The cyclic shift α_p of SRS is given by the following equation.

$${α}_{p} = 2 π \frac{{n}_{SRS}^{cs , p}}{8} \\ {n}_{SRS}^{cs , p} = ( {n}_{SRS}^{cs} + \frac{8 p}{{N}_{ap}} ) mod 8 \\ p ∈ \{ 0 , 1 , … , {N}_{ap} - 1 \} \qquad [ Equation 16 ]$$

where n^{cs}_{SRS}={0, 1, 2, 3, 4, 5, 6, 7} is a value configured for each UE by higher-layer parameters and is separately configured by different higher-layer parameters with respect to periodic and aperiodic sounding configurations. Nₐₚ denotes the number of antenna ports used for SRS transmission.

Referring to the above-described Equation 4, in DL, an eNB uses the same physical layer cell ID N^{cell}_{ID} with respect to all UEs in generating a UE-specific RS to be transmitted to a specific cell. In a current 3GPP LTE(-A) system, since one UE receives a DL signal only in one cell, the UE needs to know only one N^{cell}_{ID} and one n^{SCID} in order to detect a UE-specific RS thereof. Meanwhile, referring to Equations 8 to 16, UEs positioned in one cell initialize a pseudo-random sequence generator for generating an RS sequence using the same N^{cell}_{ID}. In terms of one UE, since the UE transmits a UL signal towards only one cell, the UE uses only one N^{cell}_{ID} to generate a PUSCH DM RS, a PUCCH DM RS, and an SRS. That is, a conventional system, which receives a DL signal in only one cell or transmits a UL signal to only one cell, has used a cell (DL) and UE (UL) based DM RS sequences. In other words, since a DL cell and a UL cell are the same cell and UL/DL transmission is performed in only one cell in the conventional communication system, the UE only needs to acquire N^{cell}_{ID} based on DL synchronization signals (a primary synchronization signal (PSS) and a secondary synchronization signal (SSS)) received from a serving cell and use the acquired N^{cell}_{ID} to generate the UL/DL RS sequence.

However, in a DL CoMP situation, a plurality of cells or transmission points (TPs) may simultaneously participate in DL signal transmission for one UE or may selectively perform DL signal transmission to the UE. For example, one of two TPs may perform DL data transmission (e.g. PDSCH transmission) and the other TP may not perform transmission (in the case of CB/CS or DPS). As another example, both TPs may perform DL data transmission (in the case of JT). In addition, in a UL CoMP situation, one UE may perform UL transmission towards a plurality of cells or reception points (RPs) or perform UL transmission towards some of the cells or RPs. In this case, when a transmitting device transmits an RS sequence generated according to a conventional scheme, the case in which a receiving device cannot detect the RS sequence may occur.

Accordingly, for a CoMP situation in which a plurality of cells or a plurality of TPs/RPs participates in communication with a UE, a method for generating/transmitting DM RSs for data transmitted from/to different points needs to be defined even when the different TPs/RPs do not simultaneously transmit or receive data. One TP may transmit a DL signal to the UE through one or more cells and one RP may receive the DL signal from the UE through one or more cells. However, for convenience of description, the embodiments of the present invention will be described hereinbelow by referring to a cell transmitting a DL signal as a TP and a cell receiving a UL signal as an RP.

When one of two points having different cell IDs selectively transmits data to a UE or the UE selectively transmits data to one of the two points having different cell IDs, a UE-specific (UL or DL) DM RS sequence based on a cell ID designated for each point is generated and transmitted according to the present invention. The UE demodulates PDSCH data received from each point, using DL DM RS sequences received from different points. The UE generates UL DM RS sequences (e.g. PUCCH DM RS sequences, PUSCH DM RS sequences, SRSs, etc.) to be transmitted to different points, based on cell IDs designated for respective points, and transmits the UL DM RS sequences to the corresponding points.

Although the UE may acquire N^{cell} of a specific cell using a DL synchronization signal of the specific cell, the UE cannot be aware of N^{cell}_{ID} of cells other than the specific cell. In addition, even though the UE acquires a cell ID of a DL cell using the DL synchronization cell, if a DL cell is different from a UL cell, the UE cannot be aware of a cell ID of the UL cell. Therefore, according to an embodiment of the present invention, an eNB informs the UE, by higher-layer signaling, of a plurality of cell IDs that the UE is to use to generate UL/DL RS sequences. For example, the eNB may semi-statically inform the UE of a plurality of cell IDs and/or a plurality of scrambling IDs configured by RRC signaling and may dynamically inform the UE of an ID to be used at a transmission/reception timing among theses cell IDs, using DCI transmitted through a PDCCH. In DL, the eNB may dynamically indicate a cell ID associated with a PDSCH through the DCI and may transmit a DL DM RS sequence generated using the cell ID to the UE through a corresponding point together with data. The UE may discern, based on the indicated ID, which DL DM RS sequence is to be received. Accordingly, the UE may detect a DL DM RS sequence associated with DL data and demodulate the DL data using the DL DM RS. In UL, the UE may receive an ID to be used to generate a UL RS sequence through DCI, generate the UL RS sequence using the received ID, and transmit the UL RS sequence to the eNB. Since the eNB is aware of an ID used by the UE to generate the UL RS sequence, the eNB can effectively detect the UL RS sequence. The eNB may demodulate, using the UL RS sequence, UCI and/or PDSCH data received from the UE through a corresponding point.

Meanwhile, in CoMP JP and CoMP JR, a point transmitting a DL signal (hereinafter, a DL serving point) may be different from a point receiving a UL signal (hereinafter, a UL serving point). In addition, a plurality of points may participate in DL transmission or in UL reception. Accordingly, a system needs to be designed in consideration of this fact.

<PDSCH Transmission and PUCCH Transmission>

FIGS. 13 to 16 are diagrams explaining an embodiment of the present invention for PDSCH transmission and PUCCH transmission corresponding to the PDSCH transmission.

FIG. 13 illustrates PDSCH CoMP and PUCCH transmission corresponding to PDSCH CoMP. Especially, a CoMP operation based on two TPs (TP1 and TP2) and two RPs (RP1 and RP2) is illustrated in FIG. 13. In FIG. 13, TP1 corresponds to RP1 and TP2 corresponds to RP2.

Referring to FIG. 13, PDSCH1 transmission from TPI to a UE uses DM RS1 and PDSCH2 transmission from TP2 to the UE uses DM RS2. Similarly, in a UE-to-RP1 link, PUCCH1 transmission uses PUCCH RS1 and, in a UE-to-RP2 link, PUCCH2 transmission uses PUCCH RS2. In FIG. 13, according to a CoMP operation (CS/CB or JT/JR), only a part of two DLs may be used at a specific timing and corresponding UL transmission may be performed only in a part of two ULs. Activated UL-DL combinations may be variously configured according to a CoMP scheme.

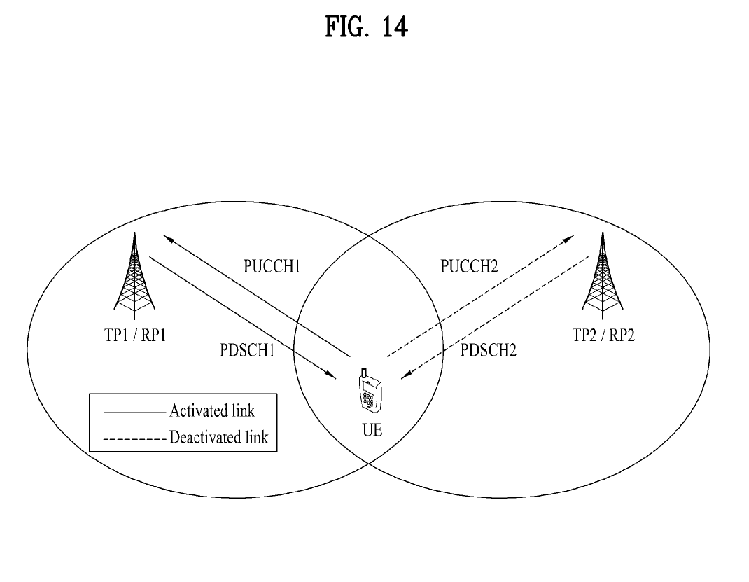

A DL serving cell and a UL serving cell may perform the same CoMP operation. FIG. 14 illustrates DL transmission and UL transmission when DL and UL are associated with the same cell ID.

Referring to FIG. 14, only TP1 among points which are capable of participating in communication with a UE may be selected for DL transmission and only PDSCH1 may be transmitted to the UE through TP1. In addition, RP1 may be selected for UL transmission as a response to PDSCH1 and only PUCCH1 may be transmitted by the UE. That is, among communication links participating in CoMP, a TP1-to-UE link and a UE-to-RP1 link may be activated and a TP2-to-UE link and a UE-to-RP2 link may be deactivated.

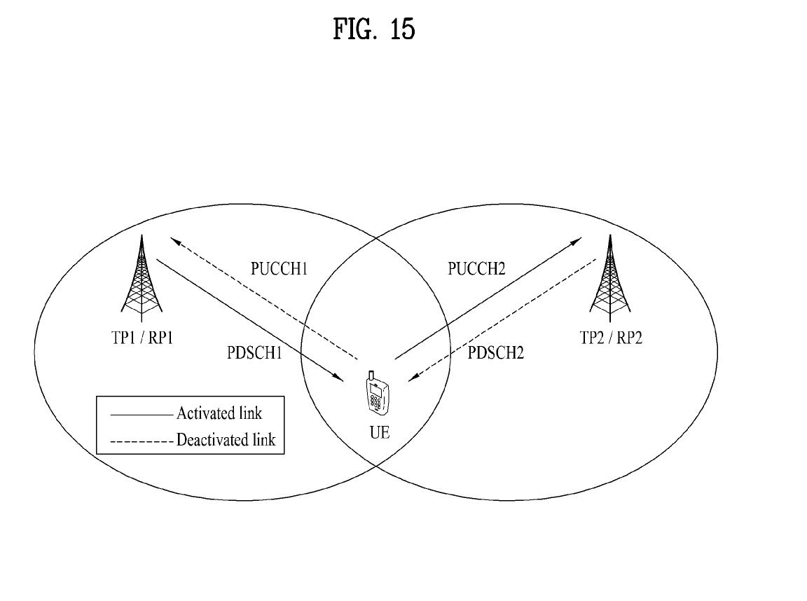

A CoMP operation in which a DL serving cell is different from a UL serving cell may be performed. FIG. 15 illustrates DL transmission and UL transmission when DL and UL are associated with different cell IDs.

Referring to FIG. 15, among points which are capable of participating in communication with a UE, a UL ACK/NACK for PDSCH1 transmission may be transmitted through PUCCH2 instead of PUCCH1.

Although operations of FIGS. 14 and 15 are the same when it is assumed that TP1 is TP2 and RP1 is RP2, the operations are performed by substantially different UL-DL combinations.

As illustrated in FIG. 14, if a DL serving cell is identical to a UL serving cell, UL transmission and DL transmission may be performed by applying only one cell ID. However, if a DL serving cell and a UL serving cell are different cells as illustrated in FIG. 15, information about different cell IDs is needed. As more cells participate in CoMP, more UL-DL combinations may be generated. Due to this, the UE should be aware of cell ID information according to various combinations in order to accurately perform DL demodulation and perform proper UL transmission (e.g. ACK/NACK PUCCH transmission) for DL demodulation. That is, the UE supporting CoMP should be aware of a cell ID and/or a scrambling ID associated with DL DM RS generation and of a cell ID and/or a scrambling ID used for UL RS generation, in each CoMP combination. Accordingly, the eNB according to an embodiment of the present invention informs the UE, by higher-layer signaling and/or physical-layer signaling, of different transmission parameters (e.g. a cell ID, a scrambling ID, etc.) according to UL and DL combinations. For example, the eNB may pre-transmit combinations of a plurality of cell IDs corresponding to possible combinations of DL serving cells and UL serving cells to the UE and transmit information indicating one combination among the combinations of the cell IDs to the UE through a PDCCH, etc. in every subframe. In other words, the eNB may configure a plurality of combinations of TP-specific transmission parameters and RP-specific transmission parameters and transmit the configured combinations to the UE so as to dynamically indicate a specific combination to be used at one transmission/reception timing (e.g. a subframe) among the plural combinations to the UE.

For example, when two TPs and two RPs participate in CoMP as illustrated in FIGS. 13, 14, and 15, the following combinations may be configured.

TABLE 9

| Set indication | Downlink cell/point | Uplink cell/point |
|---|---|---|
| 0 | TP1 (DL cell ID #1) | RP1 (UL cell ID #1) |
| 1 | TP1 (DL cell ID #1) | RP2 (UL cell ID #2) |
| 2 | TP2 (DL cell ID #2) | RP2 (UL cell ID #2) |
| 3 | TP2 (DL cell ID #2) | RP1 (UL cell ID #1) |

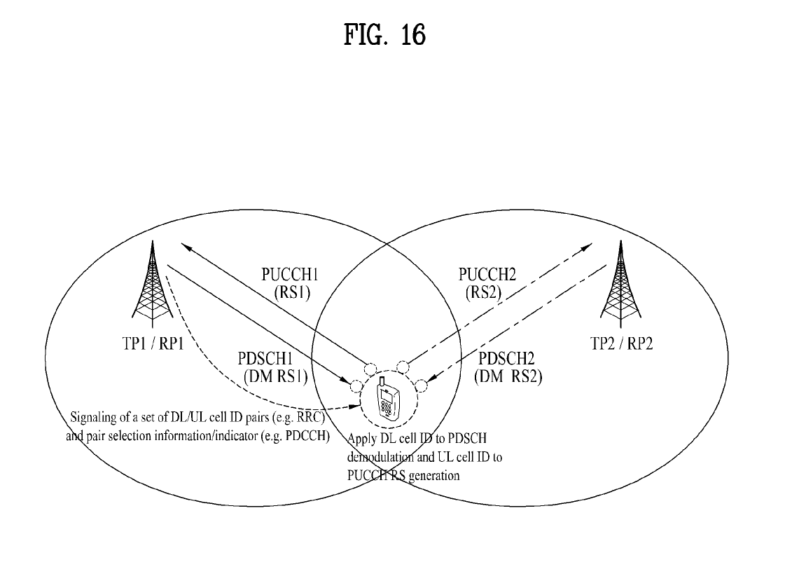

FIG. 16 illustrates a signal transmission method for DL CoMP according to an embodiment of the present invention.

Referring to FIG. 16, an eNB shares set configuration information with a UE and informs the UE of one of configured sets by additional signaling. Meanwhile, when the sets are nearly unchanged or when there is no need to change the sets, the eNB may configure, by RRC signaling, a set to be used when necessary. In the case of CoMP configured such that change of a set is cyclically generated, the eNB and the UE may be configured to change a given set every unit time without an additional indication. While a cell ID is provided from the eNB to the UE as information for DL transmission and UL transmission for CoMP in FIG. 16, other parameters (e.g. a scrambling ID) capable of achieving the present invention or distinguishing cells may be provided to the UE as DL/UL RS sequence generation information.

According to the above embodiment, the UE may acquire a DL cell ID or a scrambling ID from the eNB and use the DL cell ID or the scrambling ID as a parameter for generating a DL DM RS. Likewise, according to the above embodiment, the UE may acquire a UL cell ID or a scrambling ID from the eNB and use the UL cell ID or the scrambling ID as initial value information of a sequence generator for generating an RS sequence used for PUCCH transmission.

The RS sequence used for PUCCH transmission may be generated using a method similar to a method for obtaining an RS sequence from a base sequence used for PUSCH transmission. Referring to Equations 5 to 12, it may be appreciated that N^{cell}_{ID} (cell ID), which is an input parameter of cᵢₙᵢₜ, is used for group hopping and sequence hopping for determining the RS sequence. Consequently, UL cell ID information is needed for PUCCH transmission. Since the UL cell ID has a decisive effect on RS sequence determination, the UE uses different UL cell IDs for PUCCH transmission to different cells according to the present invention and, thus, it may be appreciated that different RS sequences are generated for PUCCH transmission to different cells. A PUCCH DM RS to be transmitted to each cell is generated using Equations 5 to 11 and the UE may use a parameter provided by the eNB by higher-layer signaling instead of N^{cell}_{ID} of a DL serving cell to generate a PUCCH DM RS sequence to be transmitted to a corresponding cell.

<PUSCH Transmission and PHICH Transmission>

The present invention described above may be similarly applied to DL PHICH transmission for UL CoMP transmission.

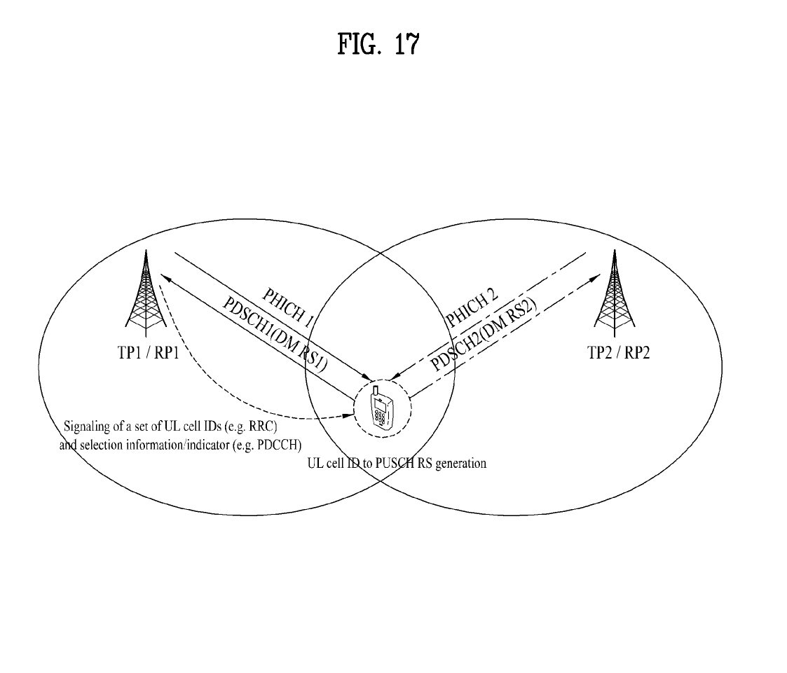

FIG. 17 illustrates a signal transmission method for UL CoMP according to an embodiment of the present invention.

For example, for UL CoMP, a target RP may differ over time. Therefore, an eNB according to the present invention informs a UE of the target RP by higher-layer signaling and/or physical-layer signaling. As an example, the eNB may transmit cell IDs for a plurality of RPs (e.g. a set of CoMP RPs) to the UE by RRC signaling and dynamically indicate, using a PDCCH (e.g. a UL grant), towards which cell a UL signal should be transmitted every unit time (e.g. subframe, radio frame, etc.) to the UE. Among a plurality of pre-received cell IDs, the UE may generate a DM RS used for UL PUSCH transmission using a cell ID indicated by the eNB.

Referring to FIG. 17, the eNB may transmit a plurality of UL cell IDs to the UE through, for example, RRC signaling, and transmit a UL grant including information indicating one UL cell ID among the plural UL cell IDs to the UE through a PDCCH. Upon detecting the UL grant in a DL subframe, the UE transmits a PUSCH in a UL subframe according to the UL grant. The UE may generate a PUSCH DM RS using the UL cell ID indicated by the UL grant and transmit the PUSCH DM RS together with UL data. For example, if a cell ID of RP1 is indicated by the PDCCH to the UE, the UE may generate PUSCH DM RS1 based on the cell ID of RP1 and, if a cell ID of RP2 is indicated by the PDCCH to the UE, the UE may generate PUSCH DM RS2 based on the cell ID of RP2. If the UE transmits PUSCH1 and PUSCH DM RS1, the network/eNB receives PUSCH1 and PUSCH DM RS1 through RP1 and, if the UE transmits PUSCH2 and PUSCH DM RS2, the network/eNB receives PUSCH2 and PUSCH DM RS2 through RP2.

ACK/NACK for a PUSCH is transmitted from the eNB to the UE through a PHICH connected to the PUSCH. The PHICH carrying HARQ ACK/NACK for the PUSCH will now be described in more detail. A plurality of PHICHs mapped to a set of the same REs forms one PHICH group and the PHICHs in the same PHICH group are distinguished by different orthogonal sequences. The PHICH resource is identified by the index pair (n^{group}_{PHICH}, n^{seq}_{PHICH}) where n^{group}_{PHICH} is the PHICH group number and n^{seq}_{PHICH} is the orthogonal sequence index within the group as defined by the following Equation.

n_{PHICH}^{group}=(I_{PRB}_{_{—}}_{RA}+n_{DMRA})mod N_{PHICH}^{group}+I_{PHICH}N_{PHICH}^{group}

n_{PHICH}^{seq}=(└I_{PRB}_{_{—}}_{RA}/N_{PHICH}^{group}┘+n_{DMRS})mod 2N_{SF}^{PHICH} [Equation 17]

In Equation 17, N^{PHICH}_{SF} is the spreading factor size used for PHICH modulation, and N^{group}_{PHICH} is the number of PHICH groups configured by higher layers. I_{PHICH} is 1 for TDD UL/DL configuration 0 with PUSCH transmission in subframe n=4 or 9, and otherwise 0. I_{PRB}_{_{—}}_{RA} is configured as I^{lowest}^{_{—}}^{indes}_{PRB}_{_{—}}_{RA} for the first transport block of a PUSCH with an associated PDCCH or for the case without an associated PDCCH when the number of NACK transport blocks is not identical to the number of transport blocks indicated by the latest PDCCH associated with a corresponding PUSCH and is configured as I^{lowest}^{_{—}}^{index}_{PRB}_{_{—}}_{RA}+1 for the second transport block of a PUSCH with an associated PDCCH. I^{lowest}^{_{—}}^{index}_{PRB}_{_{—}}_{RA} is the lowest PRB index in the first slot of PUSCH transmission.

In Equation 17, n_{DMRS} is mapped according to Table 10 from a cyclic shift for a DM RS field in the latest PDCCH having a UL DCI format for transport block(s) associated with corresponding PUSCH transmission.

TABLE 10

| Cyclic Shift for DM RS Field in | |
|---|---|
| PDCCH with uplink DCI format in | n_{DMRS} |
| 000 | 0 |
| 001 | 1 |
| 010 | 2 |
| 011 | 3 |
| 100 | 4 |
| 101 | 5 |
| 110 | 6 |
| 111 | 7 |

For reference, n_{DMRS} is set to 0 when there is no PDCCH with a UL DCI format for the same transport block or when a PUSCH for the same transport block is semi-persistently scheduled or is scheduled by a random access response grant.

As appreciated from Equation 17, if a PUSCH DM RS is determined, a PHICH group and index are correspondingly determined. That is, as a DM RS sequence used by the UE varies, a PHICH resource also varies.

Accordingly, referring to FIG. 5, if a UE transmits PUSCH1 along with DM RS1 and transmits PUSCH2 along with DM RS2, the UE may determine a PHICH1 resource for PUSCH1 based on DM RS1 to receive an ACK/NACK resource for PUSCH1 on PHICH1 and determine a PHICH2 resource for PUSCH2 based on DM RS2 to receive an ACK/NACK resource for PUSCH2 on PHICH2. Consequently, the UE according to the present embodiment receives ACK/NACK for a PUSCH through a different PHICH resource according to which cell ID is used to generate a PUSCH DM RS.

<PUCCH Transmission and PUSCH Transmission>

Upon receiving a DL grant through a PDCCH, the UE receives DL data through a PDSCH according to the DL grant and transmits ACK/NACK for the DL data through a PUCCH in a UL subframe located after the predetermined number of subframes from a subframe in which the DL data is received. For example, the UE receives DL data in subframe n through a PDSCH according to a DL grant received through a PDCCH in the subframe n and transmits ACK/NACK according to whether the DL data has been successfully decoded, through a PUCCH in subframe n+k, unless a PUSCH is allocated to the subframe n+k (e.g. k=4 in FDD) under a situation in which simultaneous transmission of the PUSCH and PUSCH is not permitted.

Meanwhile, upon receiving a UL grant through a PDCCH, the UE transmits UL data through a PUSCH according to the UL grant. For example, the UE transmits UL data through a PUSCH in subframe n′+k (e.g. k=4 in FDD) according to a UL grant received through a PDCCH in subframe n′.

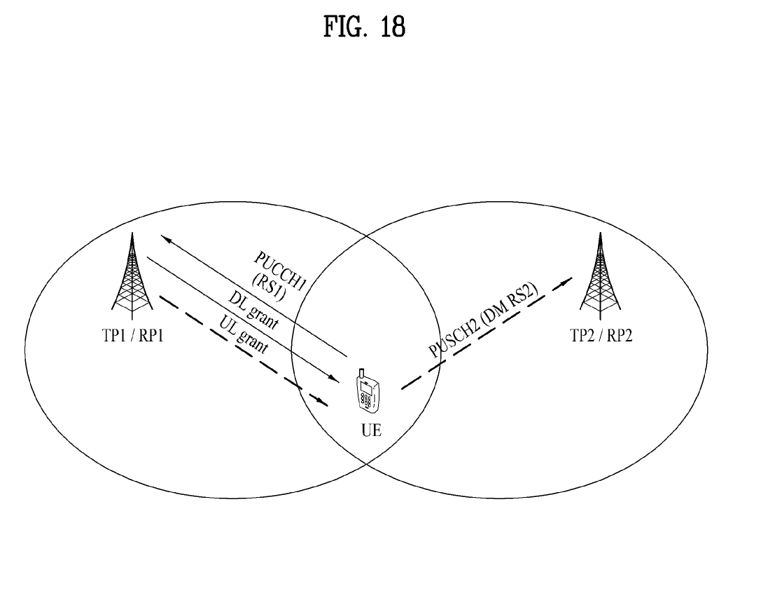

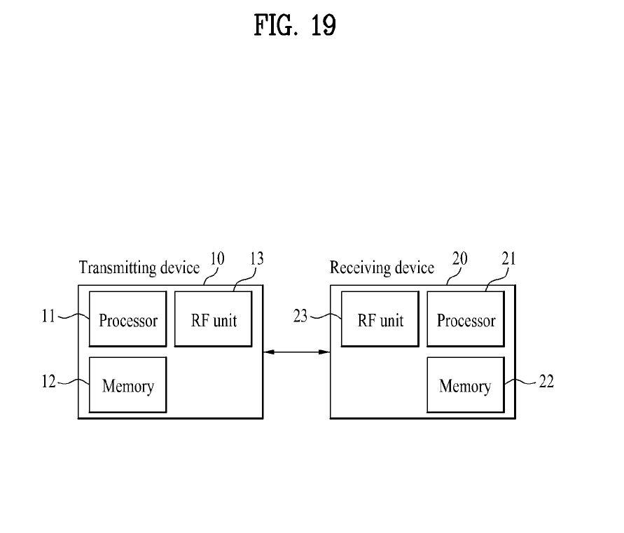

FIG. 18 illustrates a signal transmission method for DL CoMP and UL CoMP according to an embodiment of the present invention.

Assuming that a DL CoMP operation and a UL CoMP operation are independently performed and signaling for a cell ID for generating an RS sequence is separately performed with respect to DL CoMP and UL CoMP, PUCCH transmission according to a DL grant and PUSCH transmission according to a UL grant may be performed with respect to different RPs. For instance, the UE may be scheduled/indicated to transmit, towards RP1, a PUCCH (hereinafter, PUCCH1) corresponding to PDSCH transmission (hereinafter, PDSCH1) by a DL grant from TP1 and may be scheduled/indicated to transmit, towards RP2, a PUSCH (hereinafter, PUSCH2) by a UL grant from TPI. In this case, unless a PUCCH1 transmission timing and a PUSCH2 transmission timing correspond to the same subframe, the UE may transmit PUCCH1 using a cell ID of RP1 and transmit PUSCH2 using a cell ID of RP2, as in the embodiments of the present invention described earlier. In other words, the UE may generate a DM RS sequence DM RS1 for PUCCH1 based on the cell ID of RP1 to transmit DM RS1 together with PUCCH1 and generate a DM RS sequence DM RS2 for PUSCH2 based on the cell ID of RP2 to transmit DM RS2 together with PUSCH2. Since the UE cannot be simultaneously aware of the cell ID of RP1 and the cell ID of RP2 by a conventional method for obtaining a cell ID through a DL synchronization signal, the eNB according to the present invention provides the cell ID of RP1 and the cell ID of RP2 through RRC signaling or a PDCCH to the UE, as described previously, in preparation for the case in which an RP of a PUSCH is different from an RP of a PUCCH.

Meanwhile, the UE may receive both a DL grant and a UL grant in subframe n from TP1 so that a PUCCH1 transmission timing and a PUSCH2 transmission timing correspond to the same subframe. In this case, the UE, that is configured not to simultaneously transmit a PUCCH and a PUSCH, may regard PUCCH1 transmission and PUSCH2 transmission in the same subframe as a misconfiguration and may be configured to drop both PUCCH1 transmission and PUSCH2 transmission. Alternatively, the UE may be configured to piggyback PUCCH2 onto PUSCH2 and transmit PUCCH2 piggybacked onto PUSCH2 towards RP2. If the UE is configured to simultaneously transmit a PUCCH and a PUSCH, the UE may independently transmit the PUCCH and the PUSCH towards different RPs and generate a PUCCH DM RS and a PUSCH DM RS using different cell IDs for transmission. Even when the UE is configured to simultaneously transmit the PUCCH and the PUSCH, the UE may drop both PUCCH transmission and PUSCH transmission, may drop any one of PUCCH transmission and PUSCH transmission with priority and perform the other one, or may piggyback the PUCCH on the PUSCH to transmit the PUCCH piggybacked on the PUSCH in a PUSCH region, in consideration of difficulty in implementing simultaneous transmission of the PUCCH and the PUSCH.

As described in Equation 16, an SRS is generated using an RS sequence of Equation 5 and a group hopping pattern f_{gh}(nₛ) for the RS sequence of Equation 5 is initialized based on N^{cell}_{ID}. Accordingly, although not described in detail, a DM RS generation method using a cell ID separately signaled by the eNB may be applied to CoMP SRS generation for multiple RPs as well as PUCCH DM RS generation and PUSCH DM RS generation.

The above-described PUCCH DM RS generation method may be commonly applied to all PUCCH formats (e.g. 1/1a/1b/, 2/2a/2b, and 3).

Meanwhile, while the afore-described embodiments of the present invention have been described by taking a PUCCH DM RS as an example, the embodiments of the present invention may be applied to UCI transmitted through a PUCCH, that is, PUCCH payload. All PUCCH formats use a cell-specific cyclic shift n^{cell}_{cs}(nₛ,I) varying with the following equation together with a symbol number 1 and a slot number nₛ. Since a pseudo-random sequence generator for generating n^{cell}ₑₛ(nₛ,1) is initialized to cᵢₙᵢₜ=N^{cell}_{ID} corresponding to a primary cell during start of each radio frame, the embodiments of the present invention may be applied even to PUCCH payload.

n_{cs}^{cell}(nₛ,l)=Σᵢ₌₀⁷c(8N_{symb}^{UL}·nₛ+8l+i)·2ⁱ [Equation 18]

In Equation 18, the pseudo-random sequence c(i) is defined by Equation 2.

According to the above embodiments of the present invention, DL DM RSs from TPs having different cell IDs are generated using different cell IDs and UL RSs to RPs having different cell IDs are generated using different cell IDs. To this end, the eNB configures a plurality of cell IDs to be used to generate a UL or DL RS sequence and provides the cell IDs to the UE. The UE transmits/receives a UL/DL signal according to UL/DL scheduling information from the eNB and generates an RS sequence based on an ID corresponding to corresponding transmission among the provided cell IDs.

In the above-described embodiments of the present invention, a new UL/DL DM RS sequence is generated by changing an initial value for generating an RS sequence for DL CoMP and/or UL CoMP. In this case, a method of generating and using an additional base sequence group may be used without using an existing base sequence. Namely, an additional new base sequence may be defined and an RS sequence may be generated from the new base sequence as in a current method in which 30 base sequences are present in one RB and an RS sequence for a cell is generated by applying group hopping and sequence hopping of dividing the base sequences into 30 groups. Whether the RS sequence is generated from the existing base sequence or from the new base sequence may be determined using RRC signaling and/or a PDCCH.

In the embodiments of the present invention, if a DL cell is identical to a UL cell even when DL CoMP and/or UL CoMP is configured, the same value for the DL cell and the UL cell may be provided to the UE. If there are TPs having the same cell ID among TPs participating in DL transmission, cell IDs having the same value may be present among a plurality of cell IDs provided by the eNB to the UE. Likewise, if there are RPs having the same cell ID among RPs participating in UL reception, cell IDs having the same value may be present among the cell IDs provided by the eNB to the UE.

FIG. 19 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of it represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, the processor, RF unit, and memory included in the UE will be referred to as a UE processor, a UE RF unit, and a UE memory, respectively, and the processor, RF unit, and memory unit included in the eNB will be referred to as an eNB processor, an eNB RF unit, and an eNB memory, respectively.

In accordance with the embodiments of the present invention, the eNB processor generates a PDCCH, a PDSCH, and/or a DL DM RS and controls the eNB RF unit to transmit the generated PDCCH, PDSCH, and/or DL DM RS, and the UE processor controls the UE RF unit to receive the PDCCH, PDSCH, and/or DL DM RS. In accordance with the embodiments of the present invention, the UE processor generates a PUCCH, a PUSCH, a PUCCH DM RS, a PUSCH DM RS, and/or an SRS and controls the eNB RF unit to transmit the generated PUCCH, PUSCH, PUCCH DM RS, PUSCH DM RS, and/or SRS, and the eNB processor controls the eNB RF unit to receive the PUCCH, PUSCH, PUCCH DM RS, PUSCH DM RS, and/or SRS. In the present invention, each RP/TP may include at least an RF unit. When CoMP is configured, a DL TP may be different from a UL RP. However, since points participating in CoMP will be controlled by one eNB processor or cooperative eNB processors, the embodiments of the present invention will be described using the expression such as “the same eNB transmits a DL signal and receives a UL signal” in the case in which at least one of points participating in CoMP transmits the DL signal to a UE and at least one of points participating in CoMP receives the UL signal from the UE. For example, even when an eNB transmitting the DL signal is different from an eNB receiving the UL signal, the embodiments of the present invention will be described below using the expression such as “the same eNB transmits the DL signal and receives the UL signal according to the present invention”. However, the embodiments of the present invention may be applied even to the case in which an eNB transmitting the DL signal is different from an eNB receiving the UL signal.

The eNB processor according to the present invention configures a plurality of RS transmission parameters (e.g. cell IDs and/or scrambling IDs) and controls the eNB RF unit to transmit information about the configured RS transmission parameters to the UE. The RS transmission parameters may be configured according to various combinations associated with a CoMP operation. Various UL-DL combinations may be configured according to the number of cells participating in CoMP and the eNB processor may configure the RS transmission parameters including parameters to be used for UL transmission and/or parameters to be used for DL transmission by the UE according to each combination. If a plurality of TPs simultaneously or selectively participates in DL transmission, the eNB processor may configure RS transmission parameters for a specific UE so as to include a plurality of cell IDs (or scrambling IDs) corresponding to the multiple TPs for DL DM RS generation. In addition, if a plurality of RPs simultaneously or selectively participates in UL reception, the eNB processor may configure RS transmission parameters for a specific UE so as to include a plurality of cell IDs (or scrambling Ds) corresponding to the multiple RPs for UL RS (e.g. PUCCH DM RS, PUSCH DM RS, or SRS) generation.

The eNB processor may generate a DL DM RS sequence per layer used for PDSCH transmission using a DL RS transmission parameter (e.g. a DL cell ID) mapped to a corresponding TP according to a TP through which a PDSCH is transmitted to the UE and control the eNB RF unit to transmit the generated DM RS sequence to the UE together with the PDSCH. The eNB processor may control the eNB RF unit to transmit information indicating which RS transmission parameter among a plurality of RS transmission parameters configured for the UE will be used for DL transmission to the UE. The UE processor may detect DL DM RS(s) transmitted by the eNB to the UE based on the indicated RS transmission parameter among the RS transmission parameters and demodulate, using the DL DM RS(s), data received by the UE RF unit through a PDSCH. The eNB processor of the present invention generates, using different transmission parameters, PDSCH DM RSs transmitted through different TPs having different cell IDs.

Meanwhile, the eNB processor may control the eNB RF unit to transmit information indicating a UL RS transmission parameter (e.g. a UL cell ID) mapped to a corresponding RP according to an RP through which the PUCCH DM RS, PUSCH DM RS, and/or SRS is received from the UE. The UE processor generates the PUCCH DM RS, PUSCH DM RS, and/or SRS using the indicated UL RS transmission parameter among the transmission parameters and controls the UE RF unit to transmit the PUCCH DM RS, PUSCH DM RS, and/or SRS to the eNB. The eNB processor of the present invention generates UL RS transmission parameter indication information such that UL RSs to be received through RPs having different cell IDs may be generated using different RS transmission parameters. The UE processor of the present invention generates, using different UL RS transmission parameters, UL RSs to be transmitted towards RPs having different cell IDs. The UE processor controls the UE RF unit to transmit the generated UL RSs. The UE processor may control the UE RF unit to transmit an ACK/NACK PUCCH in a control region of a UL subframe together with the PUCCH DM RS, based on a DL grant from the eNB. The UE processor may control the UE RF unit to transmit an SR/CSI PUCCH in the control region of the UL subframe together with the PUCCH DM RS, based on SR/CSI configuration information. In addition, the UE processor may control the UE RF unit to transmit the PUSCH DM RS together with a PUSCH in a data region of the UL subframe, based on a UL grant from the eNB. The UE processor may control the UE RF unit to transmit the SRS on the last OFDM symbol in the data region of the UL subframe, based on SRS configuration information from the eNB. Since the eNB processor is aware of an RP through which the PUCCH and PUCCH DM RS, the PUSCH and PUSCH DM RS, or the SRS is received, the eNB processor may detect a corresponding UL RS sequence using a UL RS transmission parameter mapped to a corresponding RP and use the detected UL RS sequence for PUCCH demodulation (in the case of a PUCCH DM RS) or PUSCH demodulation (in the case of a PUSCH DM RS), or for UL channel estimation (in the case of an SRS).

According to the present invention, when a plurality of points simultaneously or selectively participate in DL transmission or UL reception, collision of RS sequences transmitted/received by the points can be prevented. That is, a situation can be prevented in which one UE cannot properly demodulate DL data in spite of receiving the same RS sequence from a plurality of RPs or one RP cannot distinguish or demodulate UL signals transmitted by different UEs in spite of receiving the same RS sequence from different UEs.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, an RN, a UE, or other devices in a wireless communication system.

1. A method for transmitting an uplink signal by a user equipment in a wireless communication system, the method comprising:
receiving a first cell identity and a second cell identity; and
transmitting an uplink control signal and a first reference signal sequence for demodulating the uplink control signal or transmitting an uplink data signal and a second reference signal sequence for demodulating the uplink data signal,
wherein the first reference signal is generated using the first cell identity and the second reference signal is generated using the second cell identity.

2. The method according to claim 1, wherein the first cell identity is different from the second cell identity.

3. The method according to claim 1, wherein the uplink control signal and the first reference signal are transmitted to a first cell and the uplink data signal and the second reference signal are transmitted to a second cell.

4. The method according to claim 1, wherein the first cell identity is the same as the second cell identity, and the uplink control signal, the first reference signal, and the uplink data signal are transmitted to the same cell.

5. A user equipment for transmitting an uplink signal in a wireless communication system, the user equipment comprising:
a radio frequency (RF) unit; and
a processor configured to control the RF unit,
wherein the processor controls the RF unit to receive a first cell identity and a second cell identity and controls the RF unit to transmit an uplink control signal and a first reference signal sequence for demodulating the uplink control signal or transmit an uplink data signal and a second reference signal sequence for demodulating the uplink data signal, and
the processor generates the first reference signal using the first cell identity and the second reference signal using the second cell identity.

6. The user equipment according to claim 5, wherein the first cell identity is different from the second cell identity.

7. The user equipment according to claim 6, wherein the uplink control signal and the first reference signal are transmitted to a first cell and the uplink data signal and the second reference signal are transmitted to a second cell.

8. The user equipment according to claim 5, wherein the first cell identity is the same as the second cell identity, and the uplink control signal, the first reference signal, and the uplink data signal are transmitted to the same cell.

9. A method for receiving an uplink signal by a base station in a wireless communication system, the method comprising:
transmitting a first cell identity and a second cell identity to a user equipment; and
receiving at least an uplink control signal and a first reference signal sequence for demodulating the uplink control signal or an uplink data signal and a second reference signal sequence for demodulating the uplink data signal, from the user equipment,
wherein the first reference signal is generated using the first cell identity and the second reference signal is generated using the second cell identity.

10. A base station for receiving an uplink signal in a wireless communication system, the base station comprising:
a radio frequency (RF) unit; and
a processor configured to control the RF unit,
wherein the processor controls the RF unit to transmit a first cell identity and a second cell identity to a user equipment and controls the RF unit to receive at least an uplink control signal and a first reference signal sequence for demodulating the uplink control signal or an uplink data signal and a second reference signal sequence for demodulating the uplink data signal, from the user equipment, and
the first reference signal is generated using the first cell identity and the second reference signal is generated using the second cell identity.
